(19) United States
(12) Patent Application Publication
(10) Pub. No.: US 2026/0304430 A1
(43) Pub. Date: Oct. 1, 2026

(54) METHODS AND DEVICES FOR DYNAMIC UPLINK WAVEFORM SWITCHING

(71) Applicant: Telefonaktiebolaget LM Ericsson (PUBL), Stockholm (SE)

(72) Inventors: Ling Su, BEIJING (CN); Yuande Tan, BEIJING (CN); Jonas Sedin, BRENTFORD Greater London (GB); Chunhui Zhang, STOCKHOLM (SE); Anqi He, BEIJING (CN); Robert Mark Harrison, GRAPEVINE, TX (US)

(21) Appl. No.: 19/100,995

(22) PCT Filed: Aug. 5, 2023
(86) PCT No.: PCT/IB2023/057939

§ 371 Date: Feb. 4, 2025

(30) Foreign Application Priority Data
Aug. 5, 2022 (WO) PCT/CN2022/110658

(51) Int. Cl. H04W 72/21; H04W 52/36

(52) U.S. Cl. CPC H04W 72/21; H04W 52/365

(57) ABSTRACT

A method (1300) implemented by a user equipment, UE, for dynamic uplink waveform switching includes transmitting (1301) a first Physical Uplink Shared Channel, PUSCH, transmission to a network device using a first waveform. The UE sends (1302) a UE report to the network device. The UE report includes information associated with a second waveform that is different from the first waveform. The UE receives (1303) an indication of the second waveform from the network device. The UE transmits (1304) a second PUSCH transmission to the network device using the second waveform based on receiving the indication to transmit using the second waveform from the network device.

### TECHNICAL FIELD

The present disclosure generally relates to communication networks, and more specifically to methods and devices for dynamic uplink waveform switching.

### BACKGROUND

Cyclic Prefix Orthogonal Frequency Division Multiplexing (CP-OFDM) is the waveform supported in uplink (UL) and downlink (DL). Discrete Fourier Transform Spread OFDM (DFT-S-OFDM) is supported for UL only, because DFTS-OFDM has lower cubic metric/Peak to Average Power Ratio (PAPR) than Orthogonal Frequency Division Multiplexing (OFDM) and, therefore, superior coverage. A terminal must implement both OFDM and DFTS-OFDM, and the network selects one. However, DFTS-OFDM just supports single layer.

Two UL waveforms, DFT-S-OFDM and CP-OFDM, have been supported in New Radio (NR) since Release 15. Thanks to its low PAPR property, DFT-S-OFDM has smaller maximum User Equipment (UE) output power reduction (MPR) than CP-OFDM, which in turn provides better performance for UEs at cell edge.

In NR Releases 15 through 17, after Radio Resource Control (RRC) connection is established, one UL waveform for Physical Uplink Shared Channel (PUSCH) with dynamic grant or configured grant is configured by RRC parameter. Later on, it is possible to switch the UL waveform by RRC reconfiguration, but the semi-static higher-layer switching has some restrictions.

Firstly, gNodeB (gNB) is not sure if the UL waveform switching can lead to higher UE transmit power. In the current UE power headroom (PHR) report based on actual transmission in Medium Access Control-Control Element (MAC CE), a UE reports its power headroom and PCMAX,f,c, both of which are calculated based on the required power backoff using the RRC configured waveform, not the target waveform. gNB can only estimate a possible transmit power increase assuming maximum power reduction (MPR) of the target waveform equals that a UE requires. gNB may underestimate the benefit of the waveform switching for UEs which apply PAPR techniques and require smaller actual power backoff than MPR for the target waveform. What's more, if P-MPR and/or A-MPR take effect, PCMAX,f,c is the result of multiple variables, and it is difficult for gNB to figure out the real power backoff a UE requires when the UE doesn't need P-MPR to ensure compliance with applicable electromagnetic energy absorption requirements.

Secondly, the increased transmit power doesn't necessarily mean increased throughput. If a UE is configured with 2-layer CP-OFDM PUSCH transmission, the switching to DFT-S-OFDM may bring higher transmission power, but not necessarily higher UE throughput as its throughput-SNR curve is flatter. FIG. 1 illustrates a schematic diagram of UE throughput versus signal to noise ratio (SNR).

Lastly, RRC reconfiguration usually causes an ambiguity time of tens of microseconds, during which the gNB doesn't know exactly when the new UL waveform starts to take effect. On the other hand, a waveform for Message 3 (Msg3) PUSCH is configured in System Information Block-1 (SIB1), which can't be changed unless SIB1 changes the configuration.

### SUMMARY

In view of the above problem, the embodiments herein propose methods, network devices, computer readable mediums and computer program products for dynamic uplink waveform switching.

According to certain embodiments, a method by a UE in a communication network, includes transmitting a first PUSCH transmission to a network device using a first waveform. The UE sends a UE report to the network device, and the UE report includes information associated with a second waveform that is different from the first waveform. The UE receives an indication of the second waveform from the network device. Based on receiving the indication to transmit using the second waveform from the network device, the UE transmits a second PUSCH transmission to the network device using the second waveform.

According to certain embodiments, a UE in a communication network is adapted to transmit a first PUSCH transmission to a network device using a first waveform. The UE is adapted to send a UE report to the network device, and the UE report includes information associated with a second waveform that is different from the first waveform. The UE is adapted to receive an indication of the second waveform from the network device. Based on receiving the indication to transmit using the second waveform from the network device, the UE is adapted to transmit a second PUSCH transmission to the network device using the second waveform.

According to certain embodiments, a method by a network device in a communication network includes receiving a first PUSCH transmission from a UE in a first waveform. The network device receives a UE report from the UE, and the UE report includes information associated with a second waveform that is different from the first waveform. Based at least in part on the UE report associated with the second waveform, the network device sends an indication to transmit using the second waveform to the UE. The network device receives a second PUSCH transmission from the UE using the second waveform.

According to certain embodiments, a network device in a communication network is adapted to receive a first PUSCH transmission from a UE in a first waveform. The network device is adapted to receive a UE report from the UE, and the UE report includes information associated with a second waveform that is different from the first waveform. Based at least in part on the UE report associated with the second waveform, the network device is adapted to send an indication to transmit using the second waveform to the UE. The network device is adapted to receive a second PUSCH transmission from the UE using the second waveform

Certain embodiments of the present disclosure may provide one or more technical advantages. For example, certain embodiments may provide a technical advantage of allowing a UE to provide assistance information so that the network can determine whether to perform UL waveform switching and/or how to schedule a PUSCH transmission with the new waveform, rather than making blind decision based on gNB estimation of UE transmission power after waveform switching. As another example, certain embodiments may provide a technical advantage of providing a method of DCI size alignment for DCI fields which have different bit width for different waveforms.

Other advantages may be readily apparent to one having skill in the art. Certain embodiments may have none, some, or all of the recited advantages.

### BRIEF DESCRIPTION OF THE DRAWINGS

The present disclosure may be best understood by way of example with reference to the following description and accompanying drawings that are used to illustrate embodiments of the present disclosure.

FIG. 1 illustrates a schematic diagram of UE throughput versus signal to noise ratio (SNR);

FIG. 2 illustrates a schematic diagram of a Single Entry PHR MAC CE, according to certain embodiments;

FIG. 3 illustrates a procedure of dynamic waveform switching, according to certain embodiments;

FIG. 4 illustrates a diagram of waveform switching when UE have additional reserve power, according to certain embodiments;

FIG. 5 illustrates a diagram of waveform switching when UE does not have reserve power, according to certain embodiments;

FIG. 6 illustrates a diagram of waveform switching from no reserve power to reserve power, according to certain embodiments;

FIG. 7 illustrates a schematic diagram of Single Entry PHR MAC CE, according to certain embodiments;

FIG. 8 illustrates a schematic diagram of Single Entry PHR MAC CE, according to certain embodiments;

FIG. 9 illustrates a schematic diagram of PUSCH transmission after RA for an RRC_Connected UE, according to certain embodiments

FIGS. 10A and 10B illustrate schematic diagrams of timing relation of waveform change indicator and PUSCH transmission, according to certain embodiments

FIG. 11 illustrates a schematic diagram of switching waveform back and forth, according to certain embodiments;

FIG. 12 illustrates an example flow diagram for a method implemented by a UE for dynamic waveform switching, according to certain embodiments;

FIG. 13 illustrates another example flow diagram for a method implemented by a UE for dynamic waveform switching, according to certain embodiments;

FIG. 14 illustrates an example flow diagram for a method implemented by a network device for dynamic waveform switching, according to certain embodiments;

FIG. 15 illustrates another example flow diagram for a method implemented by a network device for dynamic waveform switching, according to certain embodiments;

FIG. 16 illustrates a communication device according to certain embodiments;

FIG. 17 illustrates a communication system includes a telecommunication network, according to certain embodiments;

FIG. 18 illustrates example implementations of the UE, base station and host computer, according to certain embodiments;

FIG. 19 illustrates a method implemented in a communication system, according to certain embodiments;

FIG. 20 illustrates a method implemented in a communication system, according to certain embodiments;

FIG. 21 illustrates a method implemented in a communication system, according to certain embodiments; and

FIG. 22 illustrates a method implemented in a communication system, according to certain embodiments.

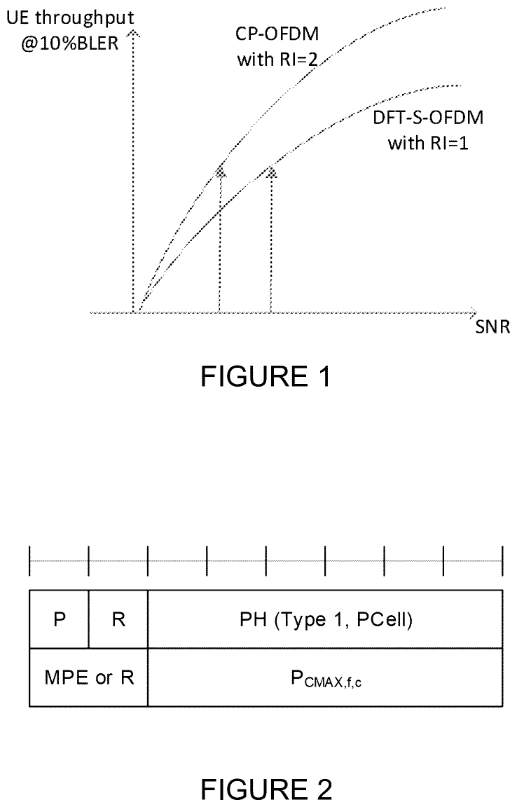

### DETAILED DESCRIPTION

The following detailed description describes methods and apparatuses for binding indication. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

As used herein, the terms “first”, “second” and so forth refer to different elements. The singular forms “a”, “an”, and “the” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “according to” is to be read as “at least in part according to”. The term “one embodiment” and “an embodiment” are to be read as “at least one embodiment”. The term “another embodiment” is to be read as “at least one other embodiment”.

Unless otherwise defined, all terms (including technical and scientific terms) used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of or one or more physical network interfaces to establish network connections (to transmit and/or receive code and/or data using propagating signals) with other electronic devices. One or more parts of an embodiment of the present disclosure may be implemented using different combinations of software, firmware, and/or hardware.

As used herein, the term “node” is used to refer to a network node or a UE. In some embodiments, generic terminology such as “radio network node” or simply “network node (NW node)” is used. Examples of network nodes are NodeB, base station (BS), multi-standard radio (MSR) radio node such as MSR BS, evolved NodeB (eNB), gNodeB (gNB), Master eNB (MeNB), Secondary eNB (SeNB), integrated access backhaul (IAB) node, network controller, radio network controller (RNC), base station controller (BSC), relay node, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., MSC, MME, etc.), Operations & Maintenance (O&M), OSS, SON, positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE (MTC UE) or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

According to certain embodiments, a method is provided that is implemented by a UE for dynamic uplink waveform switching and includes the UE transmitting a first PUSCH transmission to a network device using a first waveform and sending a UE report to the network device. The UE report includes a waveform switching information corresponding to if the PUSCH were to be transmitted using a second waveform, and the second waveform is different from the first waveform. The UE may transmit a second transmission to the network device using the second waveform if receiving an indication to transmit using the second waveform from the network device.

According to certain embodiments, a method implemented by a network device for dynamic uplink waveform switching is provided and includes the network device configuring a UE to provide a UE report that includes waveform switching information. The network device may receive a first PUSCH transmission from a UE in a first waveform and receive a UE report from the UE. The UE report includes waveform switching information corresponding to if the PUSCH were to be transmitted using a second waveform. The second waveform is different from the first waveform. The network device may further determine whether to switch the UE to transmit using a second waveform based on the waveform switching information. The network device may send an indication to transmit using the second waveform to the UE if the network device determines to switch the UE to transmit using a second waveform. The network device may receive a second transmission from the UE using the second waveform.

According to certain embodiments, a communication device in a communication network is provided that includes a processor and a memory communicatively coupled to the processor. The memory may be adapted to store instructions which, when executed by the processor, cause the communication device to perform steps of the methods described above.

According to certain embodiments, a non-transitory machine-readable medium having a computer program stored thereon is provided. The computer program, when executed by a set of one or more processors of a communication device, causes the communication device to perform steps of the methods according described above.

### Power Headroom Reporting

According to 3GPP TS 38.3321 v17.0.0, the UE is required to report the UE configured maximum output power (P_{CMAX,c,f}) together with the power headroom. PHR is transmitted by MAC CE. More specifically, 3GPP TS 38.3321 v17.0.0 discloses:
The Power Headroom reporting procedure is used to provide the serving gNB with the following information:
   Type 1 power headroom: the difference between the nominal UE maximum transmit power and the estimated power for UL-SCH transmission per activated Serving Cell;
   Type 2 power headroom: the difference between the nominal UE maximum transmit power and the estimated power for UL-SCH and PUCCH transmission on SpCell of the other MAC entity (i.e. E-UTRA MAC entity in EN-DC, NE-DC, and NGEN-DC cases);
   Type 3 power headroom: the difference between the nominal UE maximum transmit power and the estimated power for SRS transmission per activated Serving Cell.
   MPE P-MPR: the power backoff to meet the MPE FR2 requirements for a Serving Cell operating on FR2.
RRC controls Power Headroom reporting by configuring the following parameters:
   phr-PeriodicTimer;
   phr-ProhibitTimer;
   phr-Tx-PowerFactorChange;
   phr-Type 2OtherCell;
   phr-ModeOtherCG;
   multiplePHR;
   mpe-Reporting-FR2;
   mpe-ProhibitTimer;
   mpe-Threshold;
   numberOfN;
   mpe-ResourcePool.
A Power Headroom Report (PHR) shall be triggered if any of the following events occur:
   phr-ProhibitTimer expires or has expired and the path loss has changed more than phr-Tx-Power FactorChange dB for at least one RS used as pathloss reference for one activated Serving Cell of any MAC entity of which the active DL Bandwidth Part (BWP) is not dormant BWP since the last transmission of a PHR in this MAC entity when the MAC entity has UL resources for new transmission;
NOTE 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331 [5].
   phr-PeriodicTimer expires;
   upon configuration or reconfiguration of the power headroom reporting functionality by upper layers, which is not used to disable the function;
   activation of an SCell of any MAC entity with configured uplink of which firstActiveDownlinkBWP-Id is not set to dormant BWP;
   activation of an SCG;
   addition of the PSCell except if the SCG is deactivated (i.e. PSCell is newly added or changed);
   phr-ProhibitTimer expires or has expired, when the MAC entity has UL resources for new transmission, and the following is true for any of the activated Serving Cells of any MAC entity with configured uplink:
      there are UL resources allocated for transmission or there is a PUCCH transmission on this cell, and the required power backoff due to power management (as allowed by P-MPR. as specified in TS 38.101-1, TS 38.101-2, and TS 38.101-3) for this cell has changed more than phr-Tx-PowerFactorChange dB since the last transmission of a PHR when the MAC entity had UL resources allocated for transmission or PUCCH transmission on this cell.
   Upon switching of activated BWP from dormant BWP to non-dormant DL BWP of an SCell of any MAC entity with configured uplink;
   if mpe-Reporting-FR2 is configured, and mpe-ProhibitTimer is not running:
      the measured P-MPR applied to meet FR2 MPE requirements as specified in TS 38.101-2 is equal to or larger than mpe-Threshold for at least one activated FR2 Serving Cell since the last transmission of a PHR in this MAC entity; or
      the measured P-MPR applied to meet FR2 MPE requirements as specified in TS 38.101-2 has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
   in which case the PHR is referred below to as ‘MPE P-MPR report’.
   phr-Tx-PowerFactorChange ENUMERATED {dB1, dB3, dB6, infinity},

PHR-Config information element

multiplePHR
Indicates if power headroom shall be reported using the Single
Entry PHR MAC control element or Multiple Entry PHR
MAC control element defined in TS 38.321 [3]. True means
to use Multiple Entry PHR MAC control element and False
means to use the Single Entry PHR MAC control element
defined in TS 38.321 [3]. The network configures this field to
true for MR-DC and UL CA for NR, and to false in all other
cases.
mpe-Reporting-FR2
Indicates whether the UE shall report MPE P-MPR in the PHR
MAC control element, as specified in TS 38.321 [3].
phr-Tx-PowerFactorChange
Value in dB for PHR reporting as specified in TS 38.321 [3].
Value dB1 corresponds to 1 dB, dB3 corresponds to 3 dB and
so on. The same value applies for each serving cell (although
the associated functionality is performed independently for
each cell).

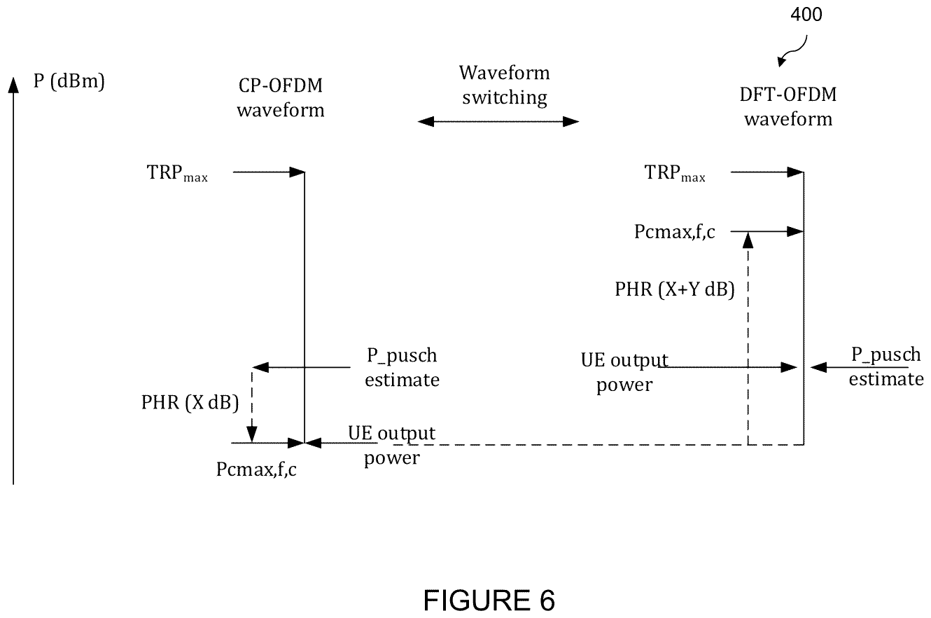

If the MAC entity has UL resources allocated for a new transmission the MAC entity shall:
   1> if it is the first UL resource allocated for a new transmission since the last MAC reset:
      2> start phr-PeriodicTimer.
   1> if the Power Headroom reporting procedure determines that at least one PHR has been triggered and not cancelled; and
   1> if the allocated UL resources can accommodate the MAC CE for PHR which the MAC entity is configured to transmit, plus its subheader, as a result of LCP as defined in clause 5.4.3.1:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> obtain the value of the Type 1 or Type 3 power headroom for the corresponding uplink carrier as specified in clause 7.7 of TS 38.213 [6] for NR Serving Cell and clause 5.1.1.2 of TS 36.213 for E-UTRA Serving Cell;
         4> if this MAC entity has UL resources allocated for transmission on this Serving Cell; or
         4> if the other MAC entity, if configured, has UL resources allocated for transmission on this Serving Cell and phr-ModeOtherCG is set to real by upper layers:
         10 5> obtain the value for the corresponding P_{CMAX,f,c} field from the physical layer.
         5> if mpe-Reporting-FR2 is configured and this Serving Cell operates on FR2 and this Serving Cell is associated to this MAC entity:
         6> obtain the value for the corresponding MPE field from the physical layer.
      3> if phr-Type 2OtherCell with value true is configured:
         4> if the other MAC entity is E-UTRA MAC entity:
         5> obtain the value of the Type 2 power headroom for the SpCell of the other MAC entity (i.e. E-UTRA MAC entity);
         5> if phr-ModeOtherCG is set to real by upper layers:
         6> obtain the value for the corresponding P_{CMAX,f,c} field for the SpCell of the other MAC entity (i.e. E-UTRA MAC entity) from the physical layer.
      3> instruct the Multiplexing and Assembly procedure to generate and transmit the Multiple Entry PHR MAC CE as defined in clause 6.1.3.9 based on the values reported by the physical layer.
      2> else (i.e. Single Entry PHR format is used):
      3> obtain the value of the Type 1 power headroom from the physical layer for the corresponding uplink carrier of the PCell;
      3> obtain the value for the corresponding P_{CMAX,f,c} field from the physical layer;
      3> if mpe-Reporting-FR2 is configured and this Serving Cell operates on FR2:
         4> obtain the value for the corresponding MPE field from the physical layer.
      3> instruct the Multiplexing and Assembly procedure to generate and transmit the Single Entry PHR MAC CE as defined in clause 6.1.3.8 based on the values reported by the physical layer.
      2> if this PHR report is an MPE P-MPR report:
         3> start or restart the mpe-ProhibitTimer;
         3> cancel triggered MPE P-MPR reporting for Serving Cells included in the PHR MAC CE.
      2> start or restart phr-PeriodicTimer;
      2> start or restart phr-ProhibitTimer;
      2> cancel all triggered PHR(s).
All triggered PHRs shall be cancelled when there is an ongoing SDT procedure as in clause 5.27 and the UL grant(s) can accommodate all pending data available for transmission but is not sufficient to additionally accommodate the PHR MAC CE plus its subheader. Editor's NOTE: FFS how UE report the Enhanced PHR and how to capture it in the procedure text.
The Single Entry PHR MAC CE is identified by a MAC subheader with LCID as specified in Table 6.2.1-2. It has a fixed size and consists of two octets defined as follows (FIG. 6.1.3.8-1):
   R: Reserved bit, set to 0;
   Power Headroom (PH): This field indicates the power headroom level. The length of the field is 6 bits. The reported PH and the corresponding power headroom levels are shown in [Table 1] below (the corresponding measured values in dB are specified in TS 38.133 [11]);
   P: If mpe-Reporting-FR2 is configured and the Serving Cell operates on FR2, the MAC entity shall set this field to 0 if the applied P-MPR value, to meet MPE requirements, as specified in TS 38.101-2 [15], is less than P-MPR_00 as specified in TS 38.133 and to 1 otherwise. If mpe-Reporting-FR2 is not configured or the Serving Cell operates on FR1, this field indicates whether power backoff is applied due to power management (as allowed by P-MPR. as specified in TS 38.101-1 [14], TS 38.101-2 [15], and TS 38.101-3 [16]). The MAC entity shall set the P field to 1 if the corresponding P_{CMAX,f,c} field would have had a different value if no power backoff due to power management had been applied;
   P_{CMAX,f,c}: This field indicates the P_{CMAX,f,c} (as specified in TS 38.213 [6]) used for calculation of the preceding PH field. The reported P_{CMAX,f,c} and the corresponding nominal UE transmit power levels are shown in Table [2] (the corresponding measured values in dBm are specified in TS 38.133 [11]);
   MPE: If mpe-Reporting-FR2 is configured, and the Serving Cell operates on FR2, and if the P field is set to 1, this field indicates the applied power backoff to meet MPE requirements, as specified in TS 38.101-2 [15]. This field indicates an index to Table [3] and the corresponding measured values of P-MPR levels in dB are specified in TS 38.133 [11]. The length of the field is 2 bits. If mpe-Reporting-FR2 is not configured, or if the Serving Cell operates on FR1, or if the P field is set to 0, R bits are present instead. FIG. 2 illustrates a schematic diagram of a Single Entry PHR MAC CE according to the disclosure.

TABLE [1]
Power Headroom levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

TABLE [2]
Nominal UE transmit power level for PHR

| P_{CMAX, f, C} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

TABLE [3]
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

With regard to the Power Headroom Report, 3GPP TS 38.133 v17.0.0 discloses:

### 10.1.17.1.1 Power Headroom Report Mapping

The power headroom reporting range is from −32 . . . +38 dB. Table [4] defines the report mapping.

TABLE [4]
Power headroom report mapping

| | Measured quantity value |
|---|---|
| Reported value | (dB) |
| POWER_HEADROOM_0 | PH < −32 |
| POWER_HEADROOM_1 | −32 ≤ PH < −31 |
| POWER_HEADROOM_2 | −31 ≤ PH < −30 |
| POWER_HEADROOM_3 | −30 ≤ PH < −29 |
| . . . | . . . |
| POWER_HEADROOM_53 | 20 ≤ PH < 21 |
| POWER_HEADROOM_54 | 21 ≤ PH < 22 |
| POWER_HEADROOM_55 | 22 ≤ PH < 24 |
| POWER_HEADROOM_56 | 24 ≤ PH < 26 |
| POWER_HEADROOM_57 | 26 ≤ PH < 28 |
| POWER_HEADROOM_58 | 28 ≤ PH < 30 |
| POWER_HEADROOM_59 | 30 ≤ PH < 32 |
| POWER_HEADROOM_60 | 32 ≤ PH < 34 |
| POWER_HEADROOM_61 | 34 ≤ PH < 36 |
| POWER_HEADROOM_62 | 36 ≤ PH < 38 |
| POWER_HEADROOM_63 | PH ≥ 38 |

### 10.1.18 PC_{MAX,c,f}

The UE is required to report the UE configured maximum output power (PC_{MAX,c,f}) together with the power headroom. This clause defines the requirements for the PC_{MAX,c,f} reporting.

### 10.1.18.1 Report Mapping

The PC_{MAX,c,f} reporting range is defined from −29 dBm to 33 dBm with 1 dB resolution. Table [5] defines the reporting mapping.

TABLE [5]
Mapping of PC_{MAX, c.f}

| Reported value | Measured quantity value | Unit |
|---|---|---|
| PCMAX_C_00 | PC_{MAX, c, f} < −29 | dBm |
| PCMAX_C_01 | −29 ≤ PC_{MAX, c, f} < −28 | dBm |
| PCMAX_C_02 | −28 ≤ PC_{MAX, c, f} < −27 | dBm |
| . . . | . . . | . . . |
| PCMAX_C_61 | 31 < PC_{MAX, c, f} < 32 | dBm |
| PCMAX_C_62 | 32 ≤ PC_{MAX, c, f} < 33 | dBm |
| PCMAX_C_63 | 33 ≤ PC_{MAX, c, f} | dBm |

With regard to the Power Headroom Report, 3GPP TS 38.213 v17.1.0 discloses:
A UE determines whether a power headroom report for an activated serving cell [11, TS 38.321] is based on an actual transmission or a reference format based on the higher layer signalling of configured grant and periodic/semi-persistent sounding reference signal transmissions and downlink control information the UE received until and including the PDCCH monitoring occasion where the UE detects the first DCI format 0_0 or DCI format 0_1 scheduling an initial transmission of a transport block since a power headroom report was triggered if the power headroom report is reported on a PUSCH triggered by the first DCI. Otherwise, a UE determines whether a power headroom report is based on an actual transmission or a reference format based on the higher layer signalling of configured grant and periodic/semi-persistent sounding reference signal transmissions and downlink control information the UE received until the first uplink symbol of a configured PUSCH transmission minus T′_{proc,2}=T_{proc,2} where T_{proc,2} is determined according to [6, TS 38.214] assuming d_{2,1}=1, d_{2,2}=0, and with μ_{DL} corresponding to the subcarrier spacing of the active downlink BWP of the scheduling cell for a configured grant if the power headroom report is reported on the PUSCH using the configured grant.

### Type 1 PH Report

If a UE determines that a Type 1 power headroom report for an activated serving cell is based on an actual PUSCH transmission then, for PUSCH transmission occasion 1 on active UL BWP b of carrier of serving cell f, the UE computes the Type 1 power headroom report as

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

where

$${P}_{CMAX , f , c} ( i ) , {P}_{O \_ PUSCH , b , f , c} ( j ) , {M}_{RB , b , f , c}^{PUSCH} ( i ) , {α}_{b , f , c} ( j ) , {PL}_{b , f , c} ( {q}_{d} ) , \\ {Δ}_{TF , b , f , c} ( i ) and {f}_{b , f , c} ( i , l )$$

are defined in Clause 7.1.1.

If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as

$${PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

where \tilde{P}C_{MAXf,c}(i) is computed assuming MPR=0 dB, A-MPR=0 dB, P-MPR-0 dB. DT_{C}=0 dB. MPR, A-MPR, P-MPR and DT_{C} are defined in [8-1, TS 38.101-1], [8-2, TS38. 101-2] and [8-3, TS 38.101-3]. The remaining parameters are defined in Clause 7.1.1 where P_{O_PUSCH,b,f,c}(j) and α_{b,c,f}(j) are obtained using P_{O_NOMINAL_PUSCH, f,c}(0) and p0-PUSCH-AlphaSetId=0, PL_{b,f,c}(q_{d}) is obtained using pusch-PathlossReferenceRS-Id=0, and l=0.

### Rel-17 MPE Triggered PHR Report

Due to adherence to the MPE (maximum permissible exposure) regulation, some UL coverage penalty is incurred as the UE ends up using a sub-optimal UL transmit beam. To alleviate this issue, some enhancement in the existing PHR report is introduced where beam-specific P-MPR along with the associated CRI/SSBRI is added into the MAC-CE-based PHR report.

### MPR, A-MPR, P_{CMAX,f,c}

For example, 3GPP TS 38.101-1 v17.xx discloses:

### 6.2.2 UE Maximum Output Power Reduction

UE is allowed to reduce the maximum output power due to higher order modulations and transmit bandwidth configurations. For UE power class 2 and 3, the allowed maximum power reduction (MPR) is defined in Table 6.2.2-2 and Table [6], respectively for channel bandwidths that meets both following criteria:
   Channel bandwidth≤100 MHz
   Relative channel bandwidth≤4% for TDD bands and ≤3% for FDD bands
   Where relative channel bandwidth=2*BW_{Channel}/(F_{UL_low}+F_{UL_high})

TABLE [6]
Maximum power reduction (MPR) for power class 3

| | | MPR (dB) | | |
|---|---|---|---|---|
| | | Edge RB | Outer RB | |
| Modulation | | allocations | allocations | Inner RB allocations |
| DFT-s- | Pi/2 BPSK | ≤3.5¹ | ≤1.2¹ | ≤0.2¹ |
| OFDM | | 0.5² | 0.5² | 0² |

| | QPSK | ≤1 | 0 |
|---|---|---|---|
| | 16 QAM | ≤2 | ≤1 |
| | 64 QAM | ≤2.5 | |
| | 256 QAM | 4.5 | |
| CP- | QPSK | ≤3 | ≤1.5 |
| OFDM | 16 QAM | ≤3 | ≤2 |

| | |
|---|---|
| 64 QAM | ≤3.5 |
| 256 QAM | ≤6.5 |

NOTE 1:
Applicable for UE operating in TDD mode with PI/2 PBSK modulation and UE indicates support for UE capability powerBoosting-pi2BPSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for UE operating in FDD mode, or in TDD mode in bands other than n40, n41, n77, n78 and n79 and if the IE powerBoostPi2BPSK is set to 0 and if more than 40% of slots in radio frame are used for UL transmission for bands n40, n41, n77, n78 and n79.

In 3GPP TS 38.101-2 v17.xx, it is disclosed:
For power class 3, MPR for contiguous allocations is defined as:
where,

$$MPR = max ( {MPR}_{WT} , {MPR}_{narrow} )$$

MPR_{narrow}=2.5 dB, L_{CRB}≤1.44 MHZ, and 0≤RBₛₜₐᵣₜ<Ceil (1/3 N_{RB}) or Ceil (2/3N_{RB})≤RBₛₜₐᵣₜ≤N_{RB}-L_{CRB}, here N_{RB} is the maximum transmission bandwidth configuration defined in Table 5.3.2-1.
MPR_{WT} is the maximum power reduction due to modulation orders, transmission bandwidth configurations listed in Table 5.3.2-1, and waveform types. MPR_{WT} is defined in Table [7] and Table 6.2.2.3-2.

TABLE [7]
MPR_{WT} for power class 3, BWchannel ≤ 200 MHz

| | | MPR_{WT}, BW_{channel} ≤ 200 MHz | |
|---|---|---|---|
| | | Inner RB allocations, | |
| Modulation | | Region 1 | Edge RB allocations |
| DFT-s- | Pi/2 BPSK | 0.0 | ≤2.0 |
| OFDM | QPSK | 0.0 | ≤2.0 |
| | 16 QAM | ≤3.0 | ≤3.5 |
| | 64 QAM | ≤5.0 | ≤5.5 |
| CP- | QPSK | ≤3.5 | ≤4.0 |
| OFDM | 16 QAM | ≤5.0 | ≤5.0 |
| | 64 QAM | ≤7.5 | ≤7.5 |

### UE Additional Maximum Output Power Reduction

### 6.2.3.1 General

Additional emission requirements can be signalled by the network. Each additional emission requirement is associated with a unique network signalling (NS) value indicated in RRC signalling by an NR frequency band number of the applicable operating band and an associated value in the field additionalSpectrumEmission. Throughout this specification, the notion of indication or signalling of an NS value refers to the corresponding indication of an NR frequency band number of the applicable operating band, the IE field freqBandIndicatorNR and an associated value of additionalSpectrumEmission in the relevant RRC information elements [7].
To meet the additional requirements, additional maximum power reduction (A-MPR) is allowed for the maximum output power as specified in Table 6.2.1-1. Unless stated otherwise, the total reduction to UE maximum output power is max (MPR, A-MPR) where MPR is defined in clause 6.2.2. Outer and inner allocation notation used in clause 6.2.3 is defined in clause 6.2.2 In absence of modulation and waveform types the A-MPR applies to all modulation and waveform types.
Table 6.2.3.1-1 specifies the additional requirements with their associated network signalling values and the allowed A-MPR and applicable operating band(s) for each NS value. In case of a power class 3 UE, when IE powerBoostPi2BPSK is set to 1, power class 2 A-MPR values apply. The mapping of NR frequency band numbers and values of the additionalSpectrumEmission to network signalling labels is specified in Table 6.2.3.1-1A.
For almost contiguous allocations in CP-OFDM waveforms, the allowed A-MPR is TBD.
   additionalSpectrumEmission
The additional spectrum emission requirements to be applied by the UE on this uplink. If the field is absent, the UE uses value 0 for the additionalSpectrumEmission (see TS 38.101-1 [15], table 6.2.3.1-1A, and TS 38.101-2 [39], table 6.2.3.1-2). Network configures the same value in additionalSpectrumEmission for all uplink carrier(s) of the same band with UL configured. The additionalSpectrumEmission is applicable for all uplink carriers of the same band with UL configured.
   6.2.4 Configured transmitted power
The configured UE maximum output power P_{CMAX,f,c} for carrier f of a serving cell c shall be set such that the corresponding measured peak EIRP PUMAX,f,c is within the following bounds

$$PPowerclass - MAX ( MAX ( MPRf , c , A - MPRf , c , ) + Δ MBP , n , P - MPRf , c ) - MAX \{ T ( MAX ( MPRf , c , A - MPRf , c , ) ) , T ( P - MPRf , c ) \} ⩽ PUMAX , f , c ⩽ EIRPmax$$

while the corresponding measured total radiated power PTMAX,f,c is bounded by

$$PTMAX , f , c ⩽ TRPmax$$

with PPowerclass the UE minimum peak EIRP as specified in clause 6.2.1, EIRPmax the applicable maximum EIRP as specified in clause 6.2.1, MPRf,c as specified in clause 6.2.2, A-MPRf, c as specified in clause 6.2.3, Δ MBP,n the peak EIRP relaxation as specified in clause 6.2.1 and TRPmax the maximum TRP for the UE power class as specified in clause 6.2.1.
P-MPRf,c is the power management maximum output power reduction. The UE shall apply P-MPRf,c for carrier f of serving cell c only for the cases described below. For UE conformance testing P-MPRf,c shall be 0 dB.
   a) ensuring compliance with applicable electromagnetic power density exposure requirements and addressing unwanted emissions/self-defense requirements in case of simultaneous transmissions on multiple RAT(s) for scenarios not in scope of 3GPP RAN specifications;
   b) ensuring compliance with applicable electromagnetic power density exposure requirements in case of proximity detection is used to address such requirements that require a lower maximum output power.
NOTE 1: P-MPRf,c was introduced in the PCMAX,f,c equation such that the UE can report to the gNB the available maximum output transmit power. This information can be used by the gNB for scheduling decisions.
NOTE 2: P-MPRf,c and maxUplinkDutyCycle-FR2 may impact the maximum uplink performance for the selected UL transmission path.

### UL DCI Command

With regard to the UL DCI Command, 3GPP TS 38.212 v17.1.0 discloses:

### Format 0_1

DCI format 0_1 is used for the scheduling of one or multiple PUSCH in one cell, or indicating CG downlink feedback information (CG-DFI) to a UE.
The following information is transmitted by means of the DCI format 0_1 with CRC scrambled by C-RNTI or CS-RNTI or SP-CSI-RNTI or MCS-C-RNTI:
   Time domain resource assignment-0, 1, 2, 3, 4, 5, or 6 bits
      If the higher layer parameter pusch-TimeDomainAllocationListDCI-0-1 is not configured and if the higher layer parameter pusch-Time DomainAllocationListForMultiPUSCH is not configured and if the higher layer parameter pusch-Time DomainResourceAllocationListForMultiPUSCH-r17 is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as |log, (I)| bits, where I is the number of entries in the higher layer parameter pusch-TimeDomainAllocationList;
      If the higher layer parameter pusch-TimeDomainAllocationListDCI-0-1 is configured or if the higher layer parameter pusch-TimeDomainAllocationListForMultiPUSCH is configured or if the higher layer parameter push-Time DomainResourceAllocationListForMultiPUSCH-r17 is configured, 0, 1, 2, 3, 4, 5 or 6 bits as defined in Clause 6.1.2.1 of [6, TS38.214]. The bitwidth for this field is determined as [log₂(I)] bits, where I is the number of entries in the higher layer parameter pusch-TimeDomainAllocationListDCI-0-1 or pusch-Time DomainAllocationListForMultiPUSCH or pusch-Time DomainResourceAllocationListForMultiPUSCH-r17;
      otherwise the bitwidth for this field is determined as [log₂(I)] bits, where I is the number of entries in the default table.
   Frequency hopping flag-0 or 1 bit:
      0 bit if only resource allocation type 0 is configured, or if the higher layer parameter frequencyHopping is not configured and the higher layer parameter pusch-RepTypeIndicatorDCI-0-1 is not configured to pusch-RepTypeB, or if the higher layer parameter frequencyHoppingDCI-0-1 is not configured and pusch-RepTypeIndicatorDCI-0-1 is configured to pusch-RepTypeB, or if only resource allocation type 2 is configured;
      1 bit according to Table 7.3.1.1.1-3 otherwise, only applicable to resource allocation type 1, as defined in Clause 6.3 of [6, TS 38.214].
   Modulation and coding scheme-5 bits as defined in Clause 6.1.4.1 of [6, TS 38.214]
   New data indicator—1 bit if the number of scheduled PUSCH indicated by the Time domain resource assignment field is 1; otherwise 2, 3, 4, 5, 6, 7 or 8 bits determined based on the maximum number of schedulable PUSCH among all entries in the higher layer parameter pusch-Time Domain AllocationListForMultiPUSCH or pusch-TimeDomainResourceAllocationListForMultiPUSCH-r17, where each bit corresponds to one scheduled PUSCH as defined in clause 6.1.4 in [6, TS 38.214].
   TPC command for scheduled PUSCH-2 bits as defined in Clause 7.1.1 of [5, TS38.213]
   Second TPC command for scheduled PUSCH-2 bits as defined in Clause 7.1.1 of [5, TS38.213] if higher layer parameter SecondTPCFieldDCI-0-1 is configured; 0 bit otherwise.
   DMRS sequence initialization-0 bit if transform precoder is enabled; 1 bit if transform precoder is disabled.
   UL-SCH indicator-0 or 1 bit as follows
      0 bit if the number of scheduled PUSCH indicated by the Time domain resource assignment field is larger than 1;
      1 bit otherwise. A value of “1” indicates UL-SCH shall be transmitted on the PUSCH and a value of “0” indicates UL-SCH shall not be transmitted on the PUSCH. If a UE does not support triggering SRS only in DCI, except for DCI format 0_1 with CRC scrambled by SP-CSI-RNTI, the UE is not expected to receive a DCI format 0_1 with UL-SCH indicator of “0” and CSI request of all zero(s). If a UE supports triggering SRS only in DCI, except for DCI format 0_1 with CRC scrambled by SP-CSI-RNTI, the UE is not expected to receive a DCI format 0_1 with UL-SCH indicator of “0”, CSI request of all zero(s) and SRS request of all zero(s).

### Format 2_2

DCI format 2_2 is used for the transmission of TPC commands for PUCCH and PUSCH.
The following information is transmitted by means of the DCI format 2_2 with CRC scrambled by TPC-PUSCH-RNTI or TPC-PUCCH-RNTI:
   block number 1, block number 2, . . . , block number N
The parameter tpc-PUSCH or tpc-PUCCH provided by higher layers determines the index to the block number for an UL of a cell, with the following fields defined for each block:
   Closed loop indicator—0 or 1 bit.
      For DCI format 2_2 with TPC-PUSCH-RNTI, 0 bit if the UE is not configured with high layer parameter twoPUSCH-PC-AdjustmentStates, in which case UE assumes each block in the DCI format 2_2 is of 2 bits; 1 bit otherwise, in which case UE assumes each block in the DCI format 2_2 is of 3 bits;
      For DCI format 2_2 with TPC-PUCCH-RNTI, 0 bit if the UE is not configured with high layer parameter twoPUCCH-PC-AdjustmentStates, in which case UE assumes each block in the DCI format 2_2 is of 2 bits; 1 bit otherwise, in which case UE assumes each block in the DCI format 2_2 is of 3 bits;
      TPC command-2 bits
The number of information bits in format 2_2 shall be equal to or less than the payload size of format 1_0 monitored in common search space in the same serving cell. If the number of information bits in format 2_2 is less than the payload size of format 1_0 monitored in common search space in the same serving cell, zeros shall be appended to format 2_2 until the payload size equals that of format 1_0 monitored in common search space in the same serving cell.

### UE PUSCH Preparation Procedure Time

### Section 6.4 in 3GPP TS 38.214 Discloses:

If the first uplink symbol in the PUSCH allocation for a transport block, including the DM-RS, as defined by the slot offset K₂ and Koffset, if configured, and the start S and length L of the PUSCH allocation indicated by ‘Time domain resource assignment’ of the scheduling DCI and including the effect of the timing advance, is no earlier than at symbol L₂, where L₂ is defined as the next uplink symbol with its CP starting p_{roc,2}=max ((N₂+d_{2,1}+d₂) (2048+144)·κ₂^{=μ} T_{c}+Tₑₓₜ+T_{switch},d_{2,2}) after the end of the reception of the last symbol of the PDCCH carrying the DCI scheduling the PUSCH, then the UE shall transmit the transport block. When the PDCCH reception includes two PDCCH candidates from two respective search space sets, as described in clause 10.1 of [6, TS 38.213], for the purpose of determining the last symbol of the PDCCH carrying the DCI scheduling the PUSCH, the PDCCH candidate that ends later in time is used.

The value of 1 p_{roc,2} is used both in the case of normal and extended cyclic prefix.

TABLE [8]
PUSCH preparation time for PUSCH timing capability 1

| μ | PUSCH preparation time N₂ [symbols] |
|---|---|
| 0 | 10 |
| 1 | 12 |
| 2 | 23 |
| 3 | 36 |
| 5 | 144 |
| 6 | 288 |

TABLE [9]
PUSCH preparation time for PUSCH timing capability 2

| μ | PUSCH preparation time N₂ [symbols] |
|---|---|
| 0 | 5 |
| 1 | 5.5 |
| 2 | 11 for frequency range 1 |

### Waveform-Related Configurations

The transformPrecoder element in RRC configuration is as follows
PUSCH-Config information element
   mcs-Table ENUMERATED {qam256, qam64LowSE} OPTIONAL, —Need S
   mcs-TableTransformPrecoder ENUMERATED {qam256, qam64LowSE} OPTIONAL, —Need S
   transformPrecoder ENUMERATED {enabled, disabled} OPTIONAL, —Need S
   mcs-TableDCI-0-2-r16 ENUMERATED {qam256, qam64LowSE} OPTIONAL, —Need S
   mcs-TableTransformPrecoderDCI-0-2-r16 ENUMERATED {qam256, qam64LowSE} OPTIONAL, —Need S
mcs-Table, mcs-TableFormat0-2Indicates which MCS table the UE shall use for PUSCH without transform precoder (see TS 38.214 [19], clause 6.1.4.1). If the field is absent the UE applies the value 64QAM.
The field mcs-Table applies to DCI format 0_0 and DCI format 0_1 and the field mcs-TableDCI-0-2 applies to DCI format 0_2 (see TS 38.214 [19], clause 6.1.4.1).
mcs-TableTransformPrecoder, mcs-TableTransformPrecoderDCI-0-2Indicates which MCS table the UE shall use for PUSCH with transform precoding (see TS 38.214 [19], clause 6.1.4.1) If the field is absent the UE applies the value 64QAM.
The field mcs-TableTransformPrecoder applies to DCI format 0_0 and DCI format 0_1 and the field mcs-TableTransformPrecoderDCI-0-2 applies to DCI format 0_2 (see TS38.214 [19], clause 6.1.4.1).
   RACH-ConfigCommon information element
msg3-transformPrecoder ENUMERATED {enabled} OPTIONAL, —Need R

### Msg3-transformPrecoder

Enables the transform precoder for Msg3 transmission according to clause 6.1.3 of TS 38.214 [19]. If the field is absent, the UE disables the transformer precoder (see TS 38.213 [13], clause 8.3).

### MsgA-PUSCH-Config Information Element

msgA-TransformPrecoder-r16 ENUMERATED {enabled, disabled}
msgA-TransformPrecoder enables or disables the transform precoder for MsgA transmission (see clause 6.1.3 of TS 38.214 [19]).

### ConfiguredGrantConfig Information Element

transformPrecoder ENUMERATED {enabled, disabled} OPTIONAL, —Need S
transformPrecoder The UE specific selection of transformer precoder for PUSCH (see TS 38.214 [19], clause 6.1.3). When the field is absent the UE applies the value of the field msg3-transformPrecoder.

### DMRS-UplinkConfig Information Element

transformPrecodingDisabled SEQUENCE
scramblingID0 INTEGER (0..65535) OPTIONAL, -- Need S
scramblingID1 INTEGER (0..65535) OPTIONAL, -- Need S
...
} OPTIONAL, -- Need R
transformPrecodingEnabled SEQUENCE {
nPUSCH-Identity INTEGER(0..1007) OPTIONAL, -- Need S
sequenceGroupHopping ENUMERATED {disabled} OPTIONAL, -- Need
S
sequenceHopping ENUMERATED {enabled} OPTIONAL, -- Need S
...
} OPTIONAL, -- Need R

### PTRS-UplinkConfig Information Element

PTRS-UplinkConfig ::= SEQUENCE {
transformPrecoderDisabled SEQUENCE {
frequency Density SEQUENCE (SIZE (2)) OF INTEGER (1..276)
OPTIONAL, -- Need S
timeDensity SEQUENCE (SIZE (3)) OF INTEGER (0..29) OPTIONAL,
-- Need S
maxNrofPorts ENUMERATED {n1, n2},
resourceElementOffset ENUMERATED {offset01, offset10, offset11 }
OPTIONAL, -- Need S
ptrs-Power ENUMERATED {p00, p01, p10, p11}
} OPTIONAL, -- Need R
transformPrecoderEnabled SEQUENCE {
sampleDensity SEQUENCE (SIZE (5)) OF INTEGER (1..276),
timeDensity TransformPrecoding ENUMERATED {d2} OPTIONAL --
Need S
} OPTIONAL, -- Need R
...
}

### UE Procedure for Applying Transform Precoding on PUSCH

For a PUSCH scheduled by RAR UL grant, or for a PUSCH scheduled by fallbackRAR UL grant, or for a PUSCH scheduled by DCI format 0_0 with CRC scrambled by TC-RNTI, the UE shall consider the transform precoding either ‘enabled’ or ‘disabled’ according to the higher layer configured parameter msg3-transformPrecoder.

For a MsgA PUSCH, the UE shall consider the transform precoding either ‘enabled’ or ‘disabled’ according to the higher layer configured parameter msgA-TransformPrecoder. If higher layer parameter msgA-TransformPrecoder is not configured, the UE shall consider the transform precoding either ‘enabled’ or ‘disabled’ according to the higher layer configured parameter msg3-transformPrecoder.

For PUSCH transmission scheduled by a PDCCH with CRC scrambled by CS-RNTI with NDI=1, C-RNTI, or MCS-C-RNTI or SP-CSI-RNTI:
If the DCI with the scheduling grant was received with DCI format 0_0, the UE shall, for this PUSCH transmission, consider the transform precoding either enabled or disabled according to the higher layer configured parameter msg3-transformPrecoder.
If the DCI with the scheduling grant was not received with DCI format 0_0
If the UE is configured with the higher layer parameter transformPrecoder in pusch-Config, the UE shall, for this PUSCH transmission, consider the transform precoding either enabled or disabled according to this parameter.
If the UE is not configured with the higher layer parameter transformPrecoder in pusch-Config, the UE shall, for this PUSCH transmission, consider the transform precoding either enabled or disabled according to the higher layer configured parameter msg3-transformPrecoder.
For PUSCH transmission with a configured grant
If the UE is configured with the higher layer parameter transformPrecoder in configuredGrantConfig, the UE shall, for this PUSCH transmission, consider the transform precoding either enabled or disabled according to this parameter.
If the UE is not configured with the higher layer parameter transformPrecoder in configuredGrantConfig, the UE shall, for this PUSCH transmission, consider the transform precoding either enabled or disabled according to the higher layer configured parameter msg3-transformPrecoder.
Transform precoding is defined in section 6.3.1.4 in 3GPP TS 38.211, as copied below:
   If transform precoding is not enabled according to 6.1.3 of [6, TS38.214], y^{(λ)}(i)=x^{(λ)}(i) for each layer λ=0,1, . . . , 0−1.
   If transform precoding is enabled according to 6.1.3 of [6, TS38.214], v=1 and \tilde{x}⁽⁰⁾(i) depends on the configuration of phase-tracking reference signals.
   If the procedure in [6, TS 38.214] indicates that phase-tracking reference signals are not being used, the block of complex-valued symbols

$${x}^{( 0 )} ( 0 ) , … , {x}^{( 0 )} ( {M}_{symb}^{layer} - 1 )$$

for the single layer λ=0 shall be divided into

$${M}_{symb}^{layer} / {M}_{sc}^{PUSCH}$$

\tilde{x}⁽⁰⁾(i)=x⁽⁰⁾(i).
If the procedure in [6, TS 38.214] indicates that phase-tracking reference signals are being used, the block of complex-valued symbols

$${x}^{( 0 )} ( 0 ) , … , {x}^{( 0 )} ( {M}_{symb}^{layer} - 1 )$$

shall be divided into sets, each set corresponding to one OFDM symbol, and where set l contains

$${M}_{sc}^{PUSCH} - {ε}_{l} {N}_{samp}^{group} {N}_{group}^{PTRS}$$

symbols and is mapped to the complex-valued symbols

$${\tilde{x}}^{( 0 )} ( {lM}_{sc}^{PUSCH} + {i}^{′} )$$

corresponding to OFDM symbol/prior to transform precoding, with i′ ∈

$$\{ 0 , 1 , … , {M}_{sc}^{PUSCH} - 1 \}$$

and i′≠m. The index m of PT-RS samples in set l, the number of samples per PT-RS group

$${N}_{samp}^{group} ,$$

and the number of PT-RS groups

$${N}_{group}^{PT - RS}$$

are defined in clause 6.4.1.2.2.2. The quantity εₗ=1 when OFDM symbol l contains one or more PT-RS samples, otherwise εₗ=0.

$${y}^{( 0 )} ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} {\tilde{x}}^{( 0 )} ( l \cdot {M}_{sc}^{PUSCH} + i ) {e}^{- j \frac{2 π ik}{{M}_{sc}^{PUSCH}}}$$

Transform precoding shall be applied according to

$$k = 0 , … , {M}_{sc}^{PUSCH} - 1$$

$$l = 0 , … , {M}_{symb}^{layer} / {M}_{sc}^{PUSCH} - 1$$

resulting in a block of complex-valued symbols

$${y}^{( 0 )} ( 0 ) , … , {y}^{( 0 )} ( {M}_{symb}^{layer} - 1 ) .$$

The variable

$${M}_{sc}^{PUSCH} = {M}_{RB}^{PUSCH} \cdot {N}_{sc}^{RB} , where {M}_{RB}^{PUSCH}$$

represents the bandwidth of the PUSCH in terms of resource blocks, and shall fulfil

$${M}_{RB}^{PUSCH} = {2}^{{α}_{2}} \cdot {3}^{{α}_{3}} \cdot {5}^{{α}_{5}}$$

where α₂, α₃,α₅ is a set of non-negative integers.

### UL DMRS, Low PAPR DMRS

### Sections 6.4.1.1.1.1 and 6.4.1.1.1.2 of 3GPP TS 38.211 Discloses:

If transform precoding for PUSCH is not enabled, the sequence r(n) shall be generated according to

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1. The pseudo-random sequence generator shall be initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot

$${n}_{s , f}^{μ}$$

is the slot number within a frame, and

$${\overline{n}}_{SCID}^{\overline{λ}}$$

and λ̅ are given by
   if the higher-layer parameter dmrs-Uplink in the DMRS-UplinkConfig IE is provided

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where Δ is the CDM group defined in clause 6.4.1.1.3.
otherwise

$${\overline{n}}_{SCID}^{\overline{λ}} = {n}_{SCID}$$

$$\overline{λ} = 0$$

The quantity n_{SCID} ∈ {0,1} is
   indicated by the DM-RS initialization field, if present, either in the DCI associated with the PUSCH transmission if DCI format 0_1 or 0_2, in [4, TS 38.212] is used;
   indicated by the higher layer parameter dmrs-SeqInitialization, if present, for a Type 1 PUSCH transmission with a configured grant;
   determined by the mapping between preamble(s) and a PUSCH occasion and the associated DMRS resource for a PUSCH transmission of Type-2 random access process in [5, TS 38.213];
   determined by the mapping between SS/PBCH block(s) and a PUSCH occasion and the associated DMRS resource for a configured-grant based PUSCH transmission in RRC_INACTIVE state [5, TS 38.213];
   otherwise n_{SCID}=0.
If transform precoding for PUSCH is enabled, the reference-signal sequence r(n) shall be generated according to

$$r ( n ) = {r}_{u , v}^{( α , δ )} ( n )$$

$$n = 0 , 1 , … , {M}_{sc}^{PUSCH} / {2}^{δ} - 1$$

The input parameters of generating signals include groupHoppingEnabledTransformPrecoding or sequenceHopping and sequenceGroupHopping, nPUSCH-Identity in DMRS-UplinkConfig.
   MCS table, FDRA

The two UL waveforms can have separate MCS tables and modulation orders. π/2-BPSK is only supported by DFT-S-OFDM.

In 3GPP TS 38.214 v17.1.0, it is disclosed:
if transform precoding is disabled
   if mcs-Table in pusch-Config or configuredGrantConfig is set to ‘qam256’, => the UE shall use I_{MCS} and Table 5.1.3.1-2
   if mcs-Table in pusch-Config or configuredGrantConfig is set to ‘qam64LowSE, the UE shall use I_{MCS} and Table 5.1.3.1-3
   elseif the UE is configured with MCS-C-RNTI, and the PUSCH is scheduled by a PDCCH with CRC scrambled by MCS-C-RNTI, the UE shall use I_{MCS} and Table 5.1.3.1-3
   else the UE shall use I_{MCS} and Table 5.1.3.1-1
if transform precoder is enabled
   if mcs-TableTransformPrecoder in pusch-Config/configuredGrantConfig/is set to ‘qam256’=> the UE shall use I_{MCS} and Table 5.1.3.1-2
   mcs-TableTransformPrecoder in pusch-Config/configuredGrantConfig is set to ‘qam64LowSE’,=> the UE shall use I_{MCS} and Table 6.1.4.1-2
   elseif the UE is configured with MCS-C-RNTI=> the UE shall use I_{MCS} and Table 6.1.4.1-2
else the UE shall use I_{MCS} and Table 6.1.4.1-1

### TBS Determination by Reserved MCS

28≤I_{MCS}≤31 and transform precoding is disabled and Table 5.1.3.1-2 is used, or
28≤I_{MCS}≤31 and transform precoding is enabled,
the TBS is assumed to be as determined from the DCI transported in the latest PDCCH for the same transport block using 0≤I_{MCS}≤27 If there is no PDCCH for the same transport block using 0≤I_{MCS}≤27 and if the initial PUSCH for the same transport block is transmitted with configured grant,
   the TBS shall be determined from configuredGrantConfig for a configured grant Type 1 PUSCH.
   the TBS shall be determined from the most recent PDCCH scheduling a configured grant Type 2 PUSCH.
pi/2 BPSK is only applicable to DFT-S-OFDM.

### Frequency-Domain Resource Allocation

### In Clause 6.1.2 of 3GPP TS 38.214 v17.1.0, it is Disclosed:

Two uplink resource allocation schemes type 0 and type 1 are supported. Uplink resource allocation scheme type 0 is supported for PUSCH only when transform precoding is disabled. Uplink resource allocation scheme type 1 is supported for PUSCH for both cases when transform precoding is enabled or disabled.
If the scheduling DCI is configured to indicate the uplink resource allocation type as part of the Frequency domain resource assignment field by setting a higher layer parameter resourceAllocation in pusch-Config to ‘dynamicSwitch’, the UE shall use uplink resource allocation type 0 or type 1 as defined by this DCI field. Otherwise the UE shall use the uplink frequency resource allocation type as defined by the higher layer parameter resourceAllocation.
The UE shall assume that when the scheduling PDCCH is received with DCI format 0_0, then uplink resource allocation type 1 is used.
NR resource allocation types.
   Type 0: bitmap of RBGs, applicable for CP-OFDM
   Type 1: contiguous with start position and length, applicable for CP-OFDM and DFT-S-OFDM
For PUSCH with DFT-s-OFDM waveform
   a. At least intra-slot frequency hopping is supported for 14 symbol slot case

### Frequency Hopping

In Clause 6.3.1 of 3GPP TS 38.214 v17.1.0, it is disclosed:
In case of resource allocation type 1, whether or not transform precoding is enabled for PUSCH transmission, the UE may perform PUSCH frequency hopping, if the frequency hopping field in a corresponding detected DCI format or in a random access response UL grant is set to 1, or if for a Type 1 PUSCH transmission with a configured grant the higher layer parameter frequencyHoppingOffset is provided, otherwise no PUSCH frequency hopping is performed. When frequency hopping is enabled for PUSCH, the RE mapping is defined in clause 6.3.1.6 of [4, TS 38.211].

### RBG

A RBG is a set of consecutive virtual resource blocks defined by higher layer parameter rbg-Size configured in pusch-Config and the size of the bandwidth part as defined in Table 10 as follows:

TABLE [10]
Nominal RBG size P

| Bandwidth Part | | |
|---|---|---|
| Size | Configuration 1 | Configuration 2 |
| 1-36 | 2 | 4 |
| 37-72 | 4 | 8 |
| 73-144 | 8 | 16 |
| 145-275 | 16 | 16 |

Config 1 is the default
   Config 2 can be enabled via RRC signalling
Same RBG size irrespective of the PDSCH/PUSCH duration (i.e., slot vs. non-slot)
In frequency range 1, only ‘almost contiguous allocation’ defined in [8, TS 38.101-1] is allowed as non-contiguous allocation per component carrier for UL RB allocation for CP-OFDM.
In frequency range 2, non-contiguous allocation per component carrier for UL RB allocation for CP-OFDM is not supported.

In 3GPP TS 38.211, reference point for mapping to physical resources varies depending on UL waveform:
The reference point for k is
   subcarrier 0 in common resource block 0 if transform precoding is not enabled, and
   subcarrier 0 of the lowest-numbered resource block of the scheduled PUSCH allocation if transform precoding is enabled.

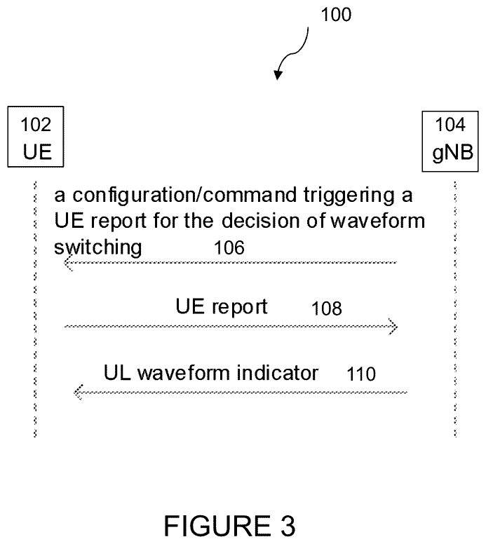

According to certain embodiments, a procedure of dynamic UL waveform switching includes a UE report to assist gNB decision of UL waveform switching, Certain embodiments may also relate to how the UE report is triggered, how a UL waveform is dynamically signalled, and the waveform-related configuration. FIG. 3 illustrates a procedure 100 for dynamic waveform switching, according to the disclosure. Specifically, FIG. 3 depicts signaling between a UE 102 and a gNB 104. As illustrated, at 106, the gNB sends a configuration/command triggering a UE report for the decision of waveform switching. At 108, the UE sends a UE report. At 110, the gNB sends a UL waveform indicator.

According to certain embodiments, the UE switches between two waveforms, facilitating the switch with a PHR for the waveform the UE switches to, assuming certain PRBs and a modulation order are used). For example, in a particular embodiment, a method in a UE for transmitting using one of a first and a second waveform includes one or more of:
a. transmitting using the first waveform in a first transmission
b. determining a first available amount of power that the UE would have if it transmitted with the second waveform, wherein the waveform is at least one of in a set of PRBs, using a modulation order, and according to a power reduction.
c. providing an indication of the first available amount of power to a network node
d. receiving an indication to transmit using the second waveform from the network node
e. transmitting using the second waveform in a second transmission.

In a particular embodiment, the first and second waveform are either DFT-S-OFDM or CP-OFDM.

In a particular embodiment, transmitting using the first and second waveform are identified as transmitting with transform precoding either enabled or disabled, and the first waveform is different from the second.

In a particular embodiment, the power headroom is determined for a transmission using the same PRBs and/or modulation as an actual transmission made by the UE. For example, in a particular embodiment, the UE transmits the first transmission in the set of PRBs and the modulation order.

In a particular embodiment, the PHR overhead is reduced by reporting the power difference between the two waveforms. For example, in a particular embodiment, the indication of the first available amount of power identifies a change in power from the first waveform that is needed to transmit the second waveform.

In a particular embodiment, the power headroom is determined for a reference format, but uses PRBs and modulation to determine the power reduction values. For example, in a particular embodiment, determining the first available amount further includes determining the power reduction according to at least one of the location of RBs occupied and the modulation state used if the UE were to transmit the second waveform.

In a particular embodiment, an event is triggered by one waveform, but PHR reporting is for both the triggering and a non-triggering waveform. For example, in a particular embodiment, the method further includes determining a second available amount of power, the power being available for transmissions using the first waveform and determining to provide the indication of the first available amount of power according to at least one of:
i. a change in the available amount of power for transmissions using the first waveform,
ii. a cell being activated,
iii. a bandwidth part being switched to a non-dormant state.
   Additionally, the method includes providing an indication of the second available amount of power to the network node.

In a particular embodiment, an event is triggered after a timer has expired by a change in power needed for the waveform not used for transmission. For example, in a particular embodiment, the method includes determining to provide the indication of the first available amount of power according to: i. a change in the determined available amount of power for transmissions using the second waveform, and ii. if a timer has expired.

In a particular embodiment, the change in power headroom is identified as a change in one or more of pathloss, power backoff, and P-MPR. For example, the method may include determining the change in available power by determining a change in one or more of a pathloss, a power backoff, and a P-MPR.

In a particular embodiment, the UE uses the indicated waveform prior to and after a random access procedure, but uses a configured waveform during the random access procedure. For example, in a particular embodiment, the method includes: receiving parameters to be used for a random access procedure, and determining a waveform to be used during the random access procedure from the parameters; initiating the random access procedure; transmitting a third transmission using during the random access procedure according to waveform determined for the random access procedure; and transmitting a fourth transmission after the random access procedure using the second waveform.in a particular embodiment PUSCH is transmitted with a different waveform no earlier than the UE's capability for switching the PUSCH waveform. For example, in a particular embodiment, the method includes the UE reporting to the network an amount of time required by the UE to transmit a PUSCH with a different waveform than the waveform the UE currently uses for PUSCH transmission; and transmitting using the second waveform no earlier than a time instant following reception of the indication to transmit using the second waveform according to the amount of time required by the UE.

In a particular embodiment, DCI field size is the same for when either waveform is used; this requires that when the DMRS sequence initialization value is used for CP-OFDM, it is still present, but ignored, when DFT-S-OFDM is used. For example, in a particular embodiment, the method includes receiving an indication of a sequence initialization value for a DMRS transmission; using the indicated sequence initialization value to initialize the DMRS transmission when the second waveform is transmitted with transform precoding disabled; and ignoring the indicated sequence initialization value when the second waveform is transmitted with transform precoding.

In a particular embodiment, the UE uses the same MCS table setting for transmissions using different waveforms. For example, in a particular embodiment, the method includes: receiving an indication of an MCS table for the UE to use to determine a modulation order and a target code rate; determining the modulation order and the target code rate according to the indication for the first and second PUSCH transmissions; and transmitting the first and second transmissions according to the determined modulation order and target code rates.

One objective of Rel-18 Coverage Enhancement WI is specifying enhancements to support dynamic switching between DFT-S-OFDM and CP-OFDM (RAN1).

Herein, unless otherwise mentioned, PUSCH includes DG-PUSCH and CG-PUSCH, single-slot PUSCH, Msg3 transmission, and multi-slot PUSCH, initial transmission and retransmission. DMRS and PTRS use the same waveform as the accompanying PUSCH.

According to certain embodiments, when UL transmission environment deteriorates, gNB can switch a UE's UL waveform from CP-OFDM to DFT-S-OFDM. Conversely, if the received UL signal strength is strong enough, gNB can switch the UL waveform from DFT-S-OFDM to CP-OFDM, which supports more flexible UL scheduling, including more FDRA types, multiple-layer transmission. In one embodiment, gNB can indicate UL waveform switching from CP-OFDM to DFT-S-OFDM or the reverse.

### a UE Report to Assist gNB Decision on UL Waveform Switching

According to certain embodiments, a gNB determines whether to trigger waveform switching for a UE and may require certain information for doing so.

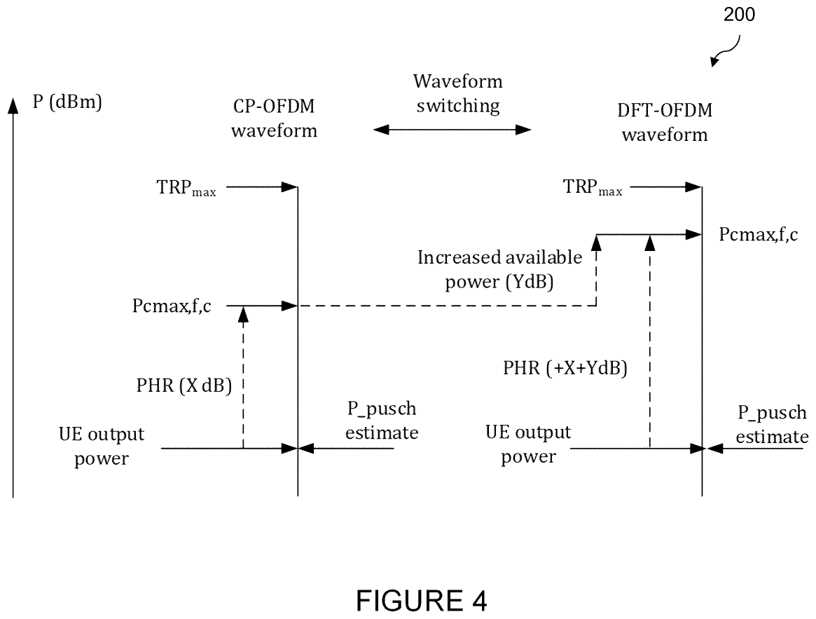

In NR Rel-17, the power headroom reporting range is from −32 . . . +38 dB. If the reduced UE-required power reduction can't make the UE power headroom from being below 0 dB to be equal to/above 0 dB, the waveform switching would not improve the UE's UL coverage as expected, as the UE is still power limited. In this case, switching the UE to another carrier or TRP can be a better choice. Or allocating the inner RBs to another promising UE would be more beneficial from the network throughput perspective. FIGS. 4, 5, and 6 illustrate different cases.

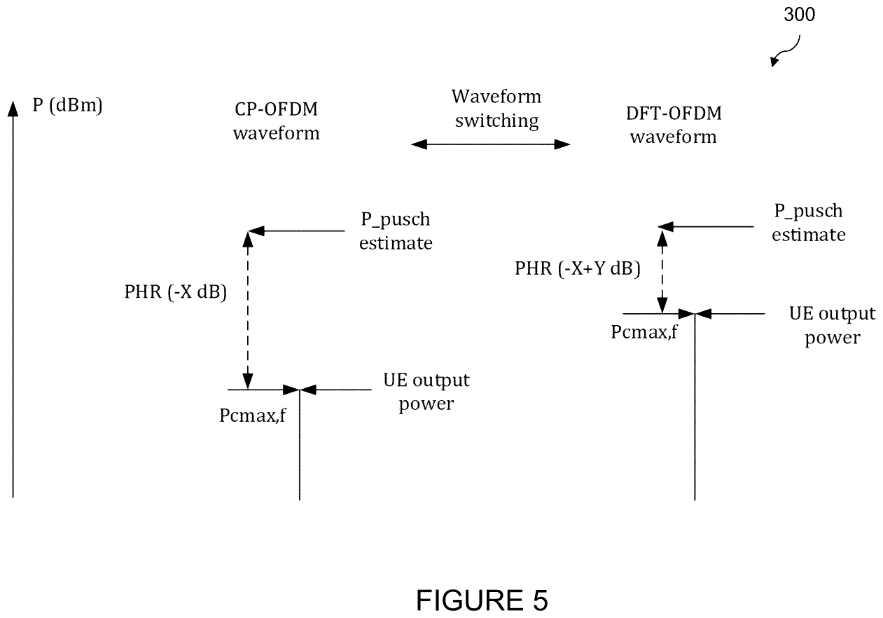

Specifically, FIG. 4 illustrates a diagram 200 of waveform switching when UE have additional reserve power and, thus, is not power-limited with both waveforms, according to certain embodiments. FIG. 5 illustrates a diagram 300 of waveform switching when UE does not have reserve power and, thus, is power-limited with both wave forms, according to certain embodiments. FIG. 6 illustrates a diagram 400 of waveform switching from no reserve power to reserve power and, thus, where a UE is power-limited with CP-OFDM but not with DFT-S-OFDM, according to certain embodiments.

The left and right portions of FIGS. 4, 5, and 6 correspond to where the UE would transmit using CP-OFDM and DFT-S-OFDM, respectively. The maximum power that the UE can transmit taking into account power reductions, P_{cmax,f,c}, is shown for each of the two waveforms, as is the maximum power that the UE can transmit, TRPₘₐₓ, which is the same for both waveforms. The power needed by the power control, which can be calculated as

$${P}_{{0}_{PUSCH} , b , f , c} ( j ) + 10 {log}_{10} ( {2}^{μ} \cdot {M}_{RB , f , c}^{PUSCH} ( i ) + {α}_{b , f , c} ( j ) \cdot {PL}_{b , f , c} ( {q}_{d} ) + {Δ}_{TF , b , f , c} ( i ) + {f}_{b , f , c} ( i , l )$$

using the notation of 3GPP TS 38.213 section 7.1.1, is denoted in FIGS. 4, 5, and 6 as P_pusch estimate. If the required power is less than or equal to P_{cmax,f,c}, the UE can transmit at the P_pusch estimate power level, while if it is greater, then the UE can transmit at most P_{cmax,f,c}. In the first example in FIG. 4, there is no need to switch waveform for the UE to be able to transmit at the power needed by the power control, while in the second and third examples in FIGS. 5 and 6, waveform switching increases the amount of power the UE can transmit (here by ‘Y’ dB).

Another aspect is that UE-required power backoff may be different from the MPR. The benefit of waveform switching may come from increased transmit power by UE switching to another waveform. The gain can be grossly estimated from the following table, copied from 3GPP TS 38.101-1 v17.0.0. MPR shrinks by 2 dB for one configuration when the UL waveform changes from CP-OFDM to DFT-S-OFDM. However, the 2 dB is estimated based on MPR rather than the power reduction a UE requires. If a UE has applied PAPR reduction techniques, it doesn't need so much power backoff as MPR, and gNB will underestimate or overestimate the gain of waveform switching for the UE. To solve the problem, a UE can inform gNB whether it can benefit from waveform switching based on the required power backoff and assist gNB for the decision.

TABLE 11
Maximum power reduction (MPR) for power class 3

| | | MPR (dB) | | |
|---|---|---|---|---|
| | | Edge RB | Outer RB | Inner RB |
| Modulation | | allocations | allocations | allocations |
| DFT-s- | Pi/2 BPSK | ≤3.5¹ | ≤1.2¹ | ≤0.2¹ |
| OFDM | | 0.5² | 0.5² | 0² |

| | QPSK | ≤1 | 0 |
|---|---|---|---|
| | 16 QAM | ≤2 | <1 |
| | 64 QAM | ≤2.5 | |
| | 256 QAM | 4.5 | |
| CP-OFDM | QPSK | ≤3 | ≤1.5 |
| | 16 QAM | ≤3 | ≤2 |

| | |
|---|---|
| 64 QAM | ≤3.5 |
| 256 QAM | ≤6.5 |

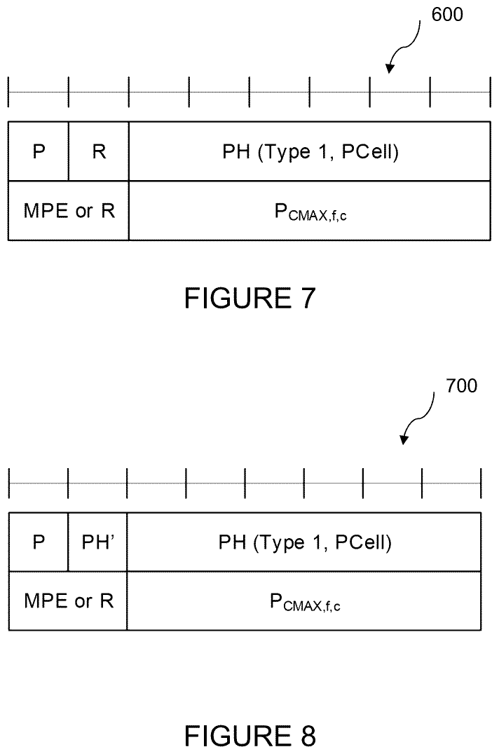

In summary, a gNB needs to know the power backoff a UE requires for a different waveform, which is not supported by current fields of a power headroom report. FIG. 7, as disclosed in 3GPP TS 38.321 v17.0.0, provides a schematic diagram 500 of Single Entry PHR MAC CE.

From FIG. 7, it can be observed that in Rel-17 the field P_{CMAX,f,c}, which is the configured maximum output power, is determined by the UE according to its required power backoff for the configured waveform that the UE uses for transmission.

According to certain embodiments, a UE may calculate PH and report the PH to the gNB to assist gNB decision of UL waveform switching. The information can be delivered in PHR report, UECapabilityInformation or a UE report generated in MAC layer or physical layer, in various embodiments, for example.

For example, in a particular embodiment, the UE may calculate the PH based on an actual PUSCH transmission, with the exception that the UE calculates its power reduction for the waveform that is not used for the actual PUSCH transmission. This can be advantageous, since power reduction and MPR depend on a variety of factors, including modulation state, location of the allocated PRBs within the carrier, bandwidth of the transmission, etc. Rel-17 PHRs based on reference formats do not include any of these factors and adding them may excessively complicate reporting based on reference formats, while using an actual format has the benefit that all the factors can be taken into account, which allows the UE to provide a more accurate power reduction value.

In another particular embodiments, the method for a Type 1 PHR based on an actual transmission from subclause 7.7.1 of 3GPP TS 38.213 is used, except that the UE calculates its power reduction for CP-OFDM if the actual transmission uses DFT-S-OFDM and for DFT-S-OFDM if the actual transmission uses CP-OFDM. The PHRs reported in this way can have the same content and structure as in section 6.1.3 of 3GPP TS 38.321, although the power reduction is calculated differently from Rel-17 PHRs.

As another example, in a particular embodiment, the UE calculates the PHR based on a reference PUSCH transmission, wherein the UE calculates \tilde{P}C_{MAX,f,c} (i) according to the equation for Type 1 power headroom report in 3GPP TS 38.213 subclause 7.7.1 based on a reference PUSCH transmission with the exceptions that MPR, A-MPR, P-MPR and/or DT_{C} are determined according to a specific modulation order and RB allocation and that the waveform that is not configured or that is not used for transmission is assumed when calculating the PHR. Using modulation and RB allocation to determine MPR, A-MPR, P-MPR and/or DT_{C} when a different waveform is used may allow a more accurate measure of power headroom that would be present when that waveform is used, since MPR, A-MPR, P-MPR and/or DT_{C} may vary according to the waveform used and the modulation or RBs occupied by a transmission.

In yet another particular and similar embodiment based on a reference PUSCH transmission, the UE calculates \tilde{P}_{CMAX,f,c}(i) according to the equation for Type 1 power headroom report in 3GPP TS 38.213 subclause 7.7.1 using a single fixed value such as 0 dB for each of MPR, A-MPR, P-MPR and DT_{C}, but where the waveform that is not configured or that is not currently used for transmission is assumed when calculating the PHR. This embodiment may be suitable for cases where the switch between waveforms is assumed to be at lower SNRs, where the difference of MPR, A-MPR, P-MPR and/or DT_{C} values between the waveforms is sufficiently small.

In still other embodiments, \tilde{P}C_{MAX,f,c} is a UE's configured maximum output power for carrier f of serving cell c in each slot based on the configured RB allocation, modulation order, and the waveform different than the currently configured one. A UE can report P_{CMAX,f,c} or the difference between P_{CMAX,f,c} and P_{CMAX,f,c}.

The reported difference shows directly the difference of power backoff a UE requires between two waveforms. If the reported difference is moderate, it indicates the UE may have different power backoff for the intended UL waveform. While the abovementioned new PHR calculation in Option 1 also considers pathloss, etc.

In still other embodiments, a UE reports a hypothesis throughput. For example, in a particular embodiment, the hypothesis throughput may indicate how much SNR improvement the waveform switching can bring with a certain PUSCH BLER, or what percentage of throughput improvement can be obtained.

In still other embodiments, a UE can report whether its required power backoff is nearly the same as/much smaller than MPR for a waveform, or whether gNB should/should not use MPR to determine whether to trigger waveform switching. This may be indicated in UECapabilityInformation.

For above disclosed embodiments, a UE may be configured target configuration(s) of a modulation order and an RB allocation, based on which to derive required power backoff, P_{CMAX}, and power headroom. The modulation order and RB allocation can be what are being used or lastly used or separately configured. A default one can be, for example, QPSK+inner RB allocation.

To quantify the report, threshold(s) may be configured/predetermined such as, for example, with a threshold of 0 dB, where value 1 indicates the measured metrics is above the threshold. The 1-bit Reserved bit can be replaced with PH′ field in the PHR report MAC CE. FIG. 8 illustrates a schematic diagram 700 of Single Entry PHR MAC CE, according to certain embodiments.

Table 12 shows an example of PH calculation for two configurations, when CP-OFDM is the RRC configured waveform. From the power headroom report, gNB can tell that the UE is still power limited (with PH=−0.5 dB) with configuration #1,but not with configuration #2 (with PH=0.5 dB).

TABLE 12

| | | PH | power |
|---|---|---|---|
| | | above 0 | headroom |
| Configurations | | dB? | (dB) |
| configuration#1 | DFT-S-OFDM, 16 QAM, | 0 | −0.5 |
| | inner RB allocation | | |
| configuration#2 | DFT-S-OFDM, QPSK, | 1 | 0.5 |
| | inner RB allocation | | |

Table 13 shows an example of hypothesis throughput. Though both configurations can improve UE power situation, only the configuration #2can bring throughput improvement about a specific threshold.

TABLE 13

| | | UE throughput | power |
|---|---|---|---|
| | | increases above | headroom |
| Configurations | | a threshold? | (dB) |
| configuration#1 | DFT-S-OFDM, 16 QAM, | 0 | 0 |
| | edge RB allocation | | |
| configuration#2 | DFT-S-OFDM, QPSK, | 1 | 1 |
| | inner RB allocation | | |

Therefore, according to certain embodiments described herein, a UE switches between two waveforms and facilitates the switch with a PHR for the waveforms the UE switches among, where the UE assumes certain PRBs are occupied and a modulation order are used. In a particular embodiment, a method in a UE for includes the UE transmits using the first waveform in a first transmission. The UE further determines a first available amount of power that the UE would have if it transmitted with the second waveform. The waveform is transmitted in a set of PRBs, using a modulation order, and would be transmitted according to a power reduction. The UE provides an indication of the first available amount of power to a network node. The UE also receives an indication to transmit using the second waveform from the network node and transmits using the second waveform in a second transmission. In some specific embodiments, transmitting using the first and second waveform are identified as transmitting with transform precoding either enabled or disabled, and the first waveform is different from the second.

As described above, it can be beneficial for the PH to be determined for a transmission using the same PRBs and/or modulation as an actual transmission made by the UE. Therefore, in a particular embodiment, the UE also transmits the first transmission in the set of PRBs and the modulation order.

The PHR overhead can be reduced by reporting the power difference between the two waveforms in some embodiments. Therefore, in a specific embodiment of the general embodiment, the indication of the first available amount of power identifies a change in power from the first waveform that is needed to transmit the second waveform.

When the power headroom is determined for a reference format, it may be beneficial to use the occupied PRBs and modulation to determine power reduction values. Therefore, in a particular embodiment, when the UE determines the first available amount of power, the UE also determines the power reduction according to at least one of the location of RBs occupied and the modulation state used if the UE were to transmit the second waveform. Rel-17 PHR reports for PUSCH provide one or more PHR for the waveform configured to the UE and used to transmit PUSCH, as described above. In embodiments where PHR is reported for a waveform that is not presently transmitted by the UE, it is possible to report only the PHR for the waveform not presently transmitted. However, this will not inform the gNB of what the PHR is for the waveform that is presently being used. Therefore, in some particular embodiments, a power headroom value for a first waveform that is presently being transmitted and an indication of a power headroom that would be available for a second waveform not being transmitted are both included in a power headroom report. Since a change of waveforms will generally require much less change in power than the range of a PHR for a waveform, it may be beneficial to indicate the PHR for the second waveform as a change in power from the first waveform that is needed to transmit the second waveform.

A benefit of indicating both the power headrooms of the first and second waveforms is that existing triggering mechanisms can be used. Rel-17 PHR transmission includes where an event triggers the PHR (where the power headroom changes more than a certain amount, a cell is activated, a BWP is switched to non-dormant, etc.) or where the PHR is transmitted periodically. Since in Rel-17 an event triggered report is for only the configured waveform, a new event triggered mechanism would be needed for a waveform not configured or used for transmission. On the other hand, if a new report is used that contains power headrooms for both the waveform used for transmission and the one not currently used for transmission, a single triggering condition could be used, such as where the trigger is according to the waveform currently used for transmission. In this way, Rel-17 triggering conditions could be used for PHRs that include power headroom for both a waveform not currently used for and for a waveform currently used for transmission. It may be observed that periodic power headroom report transmission does not depend on the headroom, and so Rel-17 mechanisms can be reused for the timing and triggering of new PHRs containing headrooms for waveforms not currently used for transmission.

Therefore, in a particular embodiment, the UE also determines a second available amount of power, which includes the power being available for transmissions using the first waveform. The UE determines to provide the indication of the first available amount of power according to at least one of: a change in the available amount of power for transmissions using the first waveform; a cell being activated; and a bandwidth part being switched to a non-dormant state. The UE further provides an indication of the second available amount of power to the network node.

In NR up to Rel-17, 3GPP TS 38.212 defines the following processing steps of UCI multiplexing in PUSCH:
Step 1: When the number of HARQ-ACK bits is less than or equal to 2, find the reserved HARQ-ACK locations.
Step 2: When the number of HARQ-ACK bits is greater than 2, map the coded HARQ-ACK bits (if any).
Step 3: Map the coded CSI part 1 and CSI part 2 bits (if any).
Step 4: Map the coded UL-SCH bits (if any).
Step 5: When the number of HARQ-ACK bits is less than or equal to 2, map the coded HARQ-ACK bits (if any).
Step 6: Form the codeword.

According to one embodiment, if the UE report is generated in the physical layer, it can be a periodic, semi-persistent, or an aperiodic report. It can be transmitted on PUCCH (as a new UCI or jointly encoded with other UCI) or multiplexed on PUSCH in one or more of the following ways:
It can be appended at the end of CSI part 2 and therefore follow the same RE mapped as CSI part 2.
If the UE report is considered as a separate UCI and to be multiplexed on PUSCH, the coded bits of UE report are mapped after CSI part 1 and CSI part 2 bits are RE mapped and before UL-SCH are mapped, i.e., between Step 3 and Step 4. It can use the same RE mapping rule after CSI part 2 bits are RE mapped. Since PHR tends to change slowly, there may be multiple opportunities to receive PHR before it changes (e.g. in the case that PHR is transmitted sufficiently frequently). This can make it suitable for transmission in CSI part 2 bits, since CSI part 2 bits can be dropped or be transmitted using a higher code rate such that there is a greater probability that they will not be decodable by the gNB if the channel fades such that the received signal is below an intended SINR operating point.

### When the UE Report is Triggered

According to certain embodiments, if the information needed for gNB decision on whether to trigger dynamic waveform switching is delivered in UE capability information, such information can be transmitted upon request. If the information is delivered in power headroom report in MAC CE, the triggering event can be based on phr-ProhibitTimer and a new threshold. The following text is an example.
A Power Headroom Report (PHR) shall be triggered if any of the following events occur:
   phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;
   phr-ProhibitTimer expires or has expired, when the MAC entity has UL resources for new transmission, and the following is true for any of the activated Serving Cells of any MAC entity with configured uplink:
   there are UL resources allocated for transmission or there is a PUCCH transmission on this cell, and the required power backoff due to power management (as allowed by P-MPR. as specified in TS 38.101-1 [14], TS 38.101-2 [15], and TS 38.101-3 [16]) for this cell has changed more than phr-Tx-Power FactorChange dB since the last transmission of a PHR when the MAC entity had UL resources allocated for transmission or PUCCH transmission on this cell.
   phr-ProhibitTimer expires or has expired and the required power backoff for a different UL waveform assuming the current modulation order and RB allocation is at least Power BackoffChange dB smaller than power backoff for the configured UL waveform.

Another way to trigger UE report is by gNB in a dynamic way. If a gNB detects a UE is suffering from UL coverage problems, e.g., by a high BLER, it can trigger the UE report for UL waveform switching.

According to a particular embodiment, to assist the decision of UL waveform switching, gNB can trigger or schedule at least one UE report as discussed in section 6.1.1 with one or more of the following ways: a UE-specific DCI or a group-common DCI, a new or reserved information field, an unused state of a field, or some bits of an information field being repurposed can trigger the report.

For example, in DCI 0_0, 0_1, 0_2, it is disclosed:

### Power Headroom Report Request—1 Bit

A MAC CE can trigger the report.

According to certain embodiments, the DCI command can trigger a UE report generated in MAC layer or physical layer. If the UE report is generated in physical layer, a computation time has to be considered, which can be reported by UE. A UE will not transmit the report earlier than the computation time after last symbol of the PDCCH triggering the report.

If UE's sensor detects MPE event happens or its measured PL changes above the threshold, the legacy PHR only happens when phr-PeriodicTimer or phr-ProhibitTimer expires. To support dynamic waveform switching, either gNB configures short timers to allow more frequency PHR report, or the UE report for dynamic waveform switching can be transmitted by UE without considering the timers.

According to one embodiment, if the required power backoff due to power management or path loss has changed more than a threshold, the UE can check if the UE report for dynamic waveform switching has reached the reporting threshold (e.g., the required power backoff for a different UL waveform assuming the current modulation order and RB allocation is at least PowerBackoffChange dB smaller than power backoff for the configured UL waveform). If so, the UE can transmit the report immediately even if phr-PeriodicTimer or phr-ProhibitTimer doesn't expire.

According to a particular embodiment, for example, the UE determines to provide the indication of the first available amount of power according to: a change in the determined available amount of power for transmissions using the second waveform; and if a timer has expired.

The change in power headroom, that is, the change in available power, can be determined using a variety of measures, according to the cause of the change in power headroom. For example, if the pathloss increases or decreases, power control in the UE may cause it to correspondingly transmit more or less power. A change in the power backoff allowed for power management, such as P-MPRc as described in 3GPP TS 38.101-1, -2, or -3, can also affect the power headroom: an increase or decrease in power backoff will correspondingly decrease or increase the power headroom. When P-MPR is reported by the UE as described in 3GPP TS 38.321 and 38.101-2, when the reported P-MPR value crosses a threshold, the UE may report the P-MPR. The amount of power backoff in this case again will correspondingly decrease or increase the power headroom.

Therefore, in according to certain particular embodiments, the UE determines the change in available power by determining a change in one or more of a pathloss, a power backoff, and a P-MPR.

### Signalling of UL Waveform

According to a particular embodiment, gNB indicates a UE a specific UL waveform or if the UE should switch the most recently used UL waveform in one or more of the following ways:
UE-specific DCI, including a DCI which schedules a DG-PUSCH or activates a Type 2 CG-PUSCH, or a DCI without scheduling UL resources, which can apply to Type 1 CG-PUSCH.
Group-common DCI, e.g. jointly encoded with or implicitly derived from TPC command in DCI 2_2
MAC CE for Type 1 CG-PUSCH.
RAR, fallback RAR, DCI 0_0 with CRC scrambled by TC-RNTI

According to a particular embodiment, the UL waveform can be indicated in DCI 0_0, 0_1, 0_2 in one or more of the following ways:
via a new or a repurposed DCI field, e.g. UL waveform indicator—1 bit, or UL waveform switching-1 bit.
implicitly by NDI field and a predetermine or RRC/DCI enabled waveform pattern, where the initial transmission of a TB uses CP-OFDM, and the retransmission of the TB uses DFT-S-OFDM. The choice of waveform depends on 1-bit NDI, and dynamic waveform switching is achieved without extra signaling of UL waveform.
jointly encoded with time domain resource assignment field. An example of specification changes based on 38.331 v17.0.0 is as follows:

PUSCH-TimeDomainResourceAllocation-r16 ::= SEQUENCE
k2-r16 INTEGER(0..32) OPTIONAL, -- Need S
pusch AllocationList-r16 SEQUENCE (SIZE(1..maxNrofMultiplePUSCHs-
r16)) OF PUSCH-Allocation-r16,
...
}
PUSCH-Allocation-r16 ::= SEQUENCE {
mappingType-r16 ENUMERATED {typeA, typeB} OPTIONAL, -- Cond
NotFormat01-02-Or-TypeA
startSymbolAndLength-r16 INTEGER (0..127) OPTIONAL, -- Cond
NotFormat01-02-Or-TypeA
startSymbol-r16 INTEGER (0..13) OPTIONAL, -- Cond RepTypeB
length-r16 INTEGER (1..14) OPTIONAL, -- Cond RepTypeB
numberOfRepetitions-r16 ENUMERATED {n1, n2, n3, n4, n7, n8, n12,
n16} OPTIONAL, -- Cond Format01-02
...,
[[
numberOfRepetitionsExt-r17 ENUMERATED {n1, n2, n3, n4, n7, n8, n12,
n16, n20, n24, n28, n32, spare4, spare3, spare2,
spare1} OPTIONAL, -- Cond Format01-02-For-TypeA
numberOfSlots-TBoMS-r17 ENUMERATED {n1, n2, n4, n8, spare4,
spare3, spare2, spare1} OPTIONAL -- Need M
]]
ulWaveformIndicator-r18 ENUMERATED {DFT-S-OFDM, CP-OFDM}
OPTIONAL
}

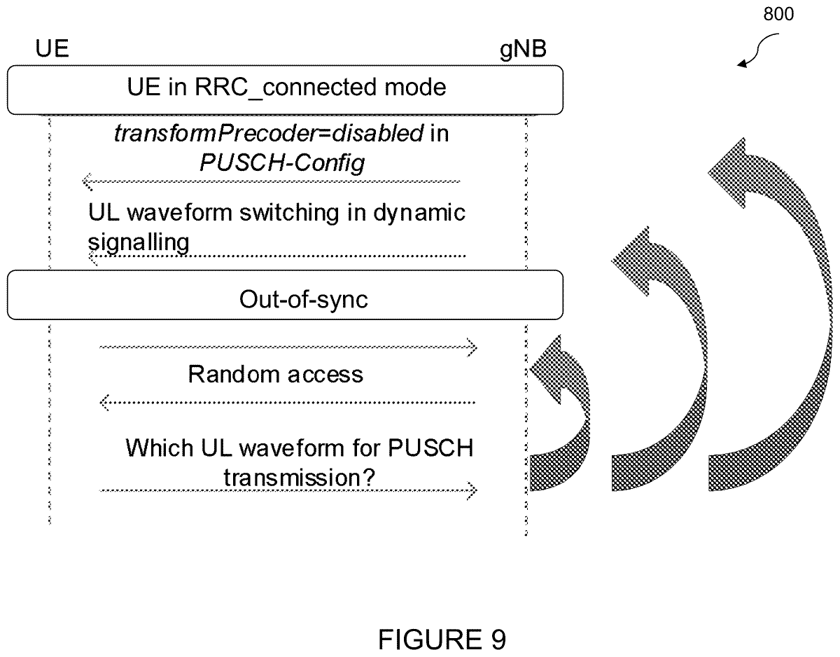

FIG. 9 illustrates a schematic diagram 800 of PUSCH transmission after RA for an RRC_Connected UE, according to certain embodiments. Consider a situation where an RRC connected UE has been configured a UL waveform different from the one indicated by transformPrecoder in PUSCH-Config with a dynamic signaling and then the UE initiates a random access procedure. If the random access is triggered by RRC connection re-establishment, beam failure recovery or handover, gNB, which may be a different target gNB, may configure a UL waveform in PUSCH-Config in RRCConnectionReconfiguration. However, in some cases, the gNB may not especially configure a UL waveform, for instance when the random access is triggered by DL or UL data arrival when UE loses its UL synchronization, or UL data arrival during RRC_CONNECTED when there are no PUCCH resources for SR available. A problem worth thinking about is whether the UE can continue using the most recently dynamically configured UL waveform for PUSH transmission or fallback to use a default waveform, e.g., the most recently semi-statically configured one. Occurrence of any of these events doesn't imply an improvement of UL coverage. Therefore, if a UE fallbacks to the RRC configured waveform, the gNB may have to trigger dynamic waveform switching to DFT-S-OFDM again, causing signaling overhead. On the other hand, fallbacking to a RRC configured waveform is more reliable than using a DCI configured one. The problem also applies to the PUSCH transmission after Random Access procedure successfully completes but before RRCConnectionReconfiguration is received, including PUSCH transmission of UECapabilityInformation, PUSCH for NAS messages, etc.

According to a particular embodiment, after random access procedure is initiated by a RRC connected UE, if a UL waveform is not configured in RRC for the following PUSCH transmission, UL waveform for PUSCH transmission is determined in one or more of the following ways:
the most recently configured UL waveform, which can be predetermined to be the most recently RRC configured or the most recently DCI indicated one
the same waveform as the preceding Msg3 transmission

Similarly, in a particular embodiment, the UE may use the indicated waveform prior to and after a random access procedure, but use a configured waveform during the random access procedure. Therefore, in a variant particular embodiment, the UE additionally receives parameters to be used for a random access procedure and determines a waveform to be used during the random access procedure from the parameters. The UE further initiates the random access procedure. The UE transmits a third transmission using during the random access procedure according to waveform determined for the random access procedure. The UE also transmits a fourth transmission after the random access procedure using the second waveform.

Rel-17 RRC_Inactive UEs, if configured with UL small data transmission (SDT), can transmit small UL data via Msg3. If the UL waveform tailored for the majority UEs in a cell is CP-OFDM as indicated by msg3-transformPrecoder in SIB1, a small number of cell edge UEs or UEs moving to cell edge can benefit from UL waveform switching for SDT.

According to a particular embodiment, for a UE which reports support of SDT and the dynamic waveform switching for Msg3, a UL waveform may be indicated in Msg2 PDCCH with CRC scrambled by RA-RNTI, RAR, fallbackRAR or DCI 0_0 with CRC scrambled by TC-RNTI. If configured, it overrides the waveform indicated by msg3-transformPrecoder.

According to a particular embodiment, if a UE receives RRCResume after Msg3 transmission, the subsequent PUSCH transmission uses the same waveform as Msg3 unless otherwise indicated.

According to a particular embodiment, in the case of carrier aggregation, the waveform indicator can be applicable to one or several specifically configured/predetermined or all active component carriers. For example, which carrier the waveform signaling applies to is consistent with the scheduled PUSCH transmission either by self-carrier or cross-carrier scheduling.

### Waveform Switching Timeline

Though the difference between CP-OFDM and DFT-OFDM from standard perspective is a baseband DFT operation, the two waveforms exhibit different PAPR characteristics and, thus, a UE may have different techniques to cope with these two waveforms, such as clipping and digital pre-distortion. These correspond to different UE implementation in baseband and/or RF frontend. When a UE is instructed to change the waveform, it may take a different preparation time to enable the circuit to transmit the respective waveform. In legacy, the waveform switching is done with RRC configure/reconfiguration, and the time factor for this is tens of microseconds, longer than UE PUSCH preparation time. In NR up to Rel-17, UE PUSCH preparation procedure time is defined as a UE baseband capability, without considering a switch of RF circuit. However, for dynamic waveform switching, for some UE implementation, it may need additional d symbols to enable the switching and get ready for PUSCH transmissions. UEs can have different capability on the switching between different waveforms. For example, one UE may be able to transmit PUSCH with a different waveform within UE PUSCH preparation time the same as legacy but other UE may need additional d symbols.

According to a particular embodiment, a UE reports its capability of UE PUSCH preparation time including waveform switching, which is no smaller than the legacy UE PUSCH preparation time.

If a UL waveform is indicated in a DCI command that also schedules UL-SCH, a UE transmits UL-SCH using the new UL waveform. However, if a UE has been allocated configured grant or it is in the middle of a multi-slot PUSCH transmission, and if a UL waveform is indicated alone, the new UL waveform can be effective according to a timeline requirement.

According to a particular embodiment, upon waveform switching signalling, the new UL waveform won't take effect earlier than a waveform switching time after the end of the signalling.

The above-described embodiments may be combined such that a PUSCH is transmitted with a different waveform no earlier than the UE's capability for switching the PUSCH waveform. Therefore, in a particular embodiment, the UE additionally reports to the network an amount of time required by the UE to transmit a PUSCH with a different waveform than the waveform the UE currently uses for PUSCH transmission. The UE transmits using the second waveform no earlier than a time instant following reception of the indication to transmit using the second waveform according to the amount of time required by the UE.

According to a particular embodiment, for a multi-slot PUSCH transmission, it can be predetermined if UL waveform switching during multi-slot transmissions is allowed, namely between PUSCH repetitions, between slots of a TBoMS transmission or between TBoMS repetitions. If it is allowed, it is up to UE capability:
If a UE is configured DMRS bundling for the multi-slot PUSCH transmission, UL waveform switching is an event which violates power consistency and phase continuity.
If a UE receives UL waveform switching signaling during a multi-slot transmission but doesn't support waveform switching during a multi-slot transmission, the new waveform takes effect starting from the transmission of the next TB, if it meets waveform switching timeline requirement.

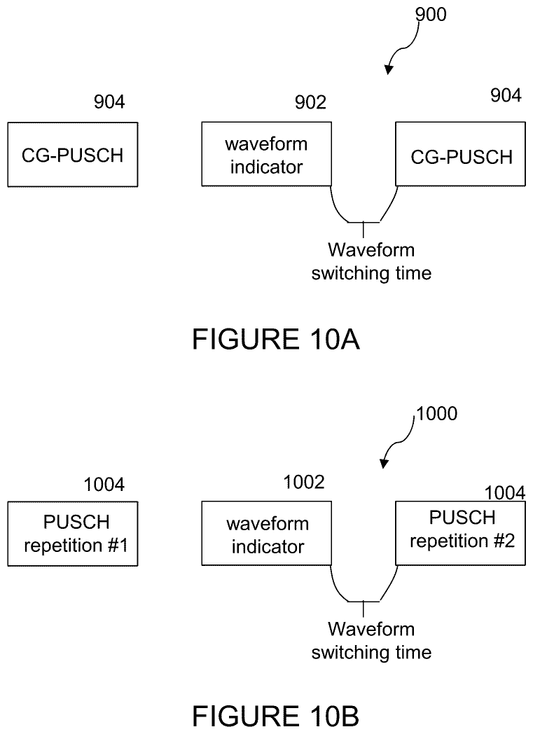

FIGS. 10A and 10B illustrates schematic diagrams 900 and 1000 of timing relation of waveform change indicator and PUSCH transmission, according to certain embodiments. Specifically, in FIG. 10A, a waveform indicator 902 is received between two CG-PUSCH 904. In FIG. 10B, a waveform indicator 1002 is received between two PUSCH repetitions 1004. In both cases, the gap between the end of waveform indicator 902, 1002 and the starting symbol of next UL transmission meets the requirement of waveform switching time. For PUSCH repetition Type A in FDD, waveform switching time no larger than (14-L) OFDM symbols can allow the UE sufficient time to switch, where L is the number of allocated UL symbols for a PUSCH repetition in a slot.

### Waveform-Related Configurations

In NR up to Rel-17, if a UE indicates a capability for dynamic power sharing between E-UTRA and NR for EN-DC or NE-DC, and

$${\hat{P}}_{MCG} ( {i}_{1} ) + {\hat{P}}_{SCG} ( {i}_{2} ) > {\hat{P}}_{Total}^{EN - DC} or {\hat{P}}_{MCG} ( {i}_{1} ) + {\hat{P}}_{SCG} ( {i}_{2} ) > {\hat{P}}_{Total}^{NE - DC} ,$$

UE reduces transmission power in any portion of slot i₁ of NR CG. With LTE of higher priority of power allocation, if UL waveform switching is triggered, the increased transmission power due to the reduced power backoff is taken advantaged by LTE CG. However, LTE and NR may have different cell coverage, a UE at NR's cell edge may not be at LTE's cell edge. With current power sharing between LTE and NR, the UE's NR UL coverage can't benefit from UL waveform switching.

According to a particular embodiment, for a UE configured with EN-DC/NE-DC and capable of dynamic power sharing, upon the waveform indicator, a UE can be indicated or predetermined if the increased output power thanks to the reduced power reduction is used by NR only or shared by NR and LTE or LTE only.

For DMRS sequence for CP-OFDM, the sequence initialization value is based on N_{SCID}, dynamically signalled by the DM-RS initialization field in DCI 0_1 or 0_2, otherwise the default value of n_{SCID} is 0. In NR up to Rel-17, a UE determines the absence/presence of ‘DMRS sequence initialization’ field in DCI based on the UL waveform configured in RRC signaling. The corresponding clauses in 3GPP TS 38.212 and 38.211 are as follows.
DMRS sequence initialization-0 bit if transform precoder is enabled; 1 bit if transform precoder is disabled.

The quantity n_{SCID} ∈ {0,1} is
indicated by the DM-RS initialization field, if present, either in the DCI associated with the PUSCH transmission if DCI format 0_1 or 0_2, in [4, TS 38.212] is used;
indicated by the higher layer parameter dmrs-SeqInitialization, if present, for a Type 1 PUSCH transmission with a configured grant;
determined by the mapping between preamble(s) and a PUSCH occasion and the associated DMRS resource for a PUSCH transmission of Type-2 random access process in [5, TS 38.213];
determined by the mapping between SS/PBCH block(s) and a PUSCH occasion and the associated DMRS resource for a configured-grant based PUSCH transmission in RRC_INACTIVE state [5, TS 38.213];
otherwise n_{SCID}=0.

With dynamic waveform switching, a waveform can possibly be disabled by RRC and enabled by DCI, or vice versa. The DCI payload size is better to be aligned with RRC configuration to be reliable. Therefore, if a UE is previously configured with CP-OFDM in RRC and indicated to switch UL waveform to DFT-S-OFDM in DCI 0_1 or 0_2, it ignores the 1-bit ‘DMRS sequence initialization’ field for the new waveform. If a UE is previously configured with DFT-S-OFDM in RRC and indicated to switch its waveform to CP-OFDM, it uses the default value of n_{SCID} for DMRS sequence initialization.

According to a particular embodiment, the field size of DMRS sequence initialization in DCI 0_1 and 0_2 is consistent with the waveform enabled in RRC, rather than DCI. The field definition in 38.212 is updated as follows:
DMRS sequence initialization-0 bit if transform precoder is enabled in RRC signaling; 1 bit if transform precoder is disabled in RRC signaling.

A variant embodiment can be where the DCI field size is the same for when either waveform is used for transmission. This can be facilitated by requiring that when the DMRS sequence initialization value is used for CP-OFDM, it is still present in DCI, but ignored when DFT-S-OFDM is used.

Therefore, in a particular embodiment, the UE also receives an indication of a sequence initialization value for a DMRS transmission. The UE uses the indicated sequence initialization value to initialize the DMRS transmission when the second waveform is transmitted with transform precoding disabled. The UE ignores the indicated sequence initialization value when the second waveform is transmitted with transform precoding.

Some RRC parameters are associated with one specific waveform, for instance MCS table. To support dynamic waveform switching, gNB can configure both mcs-Table and mcs-TableTransformPrecoder. Which of those is adopted depends on transformPrecoder is enabled or disabled by RRC and the potential dynamic waveform signaling. Table 14 shows how a MCS table is selected for PUSCH other than Msg3 transmission based on the enabled waveform and the RRC configuration. Waveform-specific RRC parameters also exist in DMRS-UplinkConfig. Therefore, such RRC configuration of both waveforms keeps gNB scheduling flexibility at the coast of increased payload size, especially when gNB is not sure dynamic waveform switching will occur. In 38.214, a default MCS table is specified for both waveforms when the MCS table is not configured in RRC for the enabled waveform as listed in the last role of Table 14. If mcs-Table is configured in RRC but not mcs-TableTransformPrecoder, upon waveform switching signaling, Table 6.1.4.1-1 is selected for DFT-S-OFDM.

PUSCH-Config information element
mcs-Table ENUMERATED {qam256, qam64LowSE} OPTIONAL, -- Need
S
mcs-TableTransformPrecoder ENUMERATED {qam256, qam64LowSE}
OPTIONAL, -- Need S
transformPrecoder ENUMERATED {enabled, disabled} OPTIONAL, --
Need S
mcs-TableDCI-0-2-r16 ENUMERATED {qam256, qam64LowSE}
OPTIONAL, -- Need S
mcs-TableTransformPrecoderDCI-0-2-r16 ENUMERATED {qam256,
qam64LowSE} OPTIONAL, -- Need S

TABLE 14

| mcs-Table or mcs- | | |
|---|---|---|
| TableTransformPrecoder, | | |
| mcs-TableDCI-0-2-r16 or mcs- | | DFT-S- |
| TableTransformPrecoderDCI-0-2-r16 | CP-OFDM | OFDM |
| ‘qam256’ | Table 5.1.3.1- | Table 5.1.3.1- |
| | 2 | 2 |
| ‘qam64LowSE’ | Table 5.1.3.1- | Table 6.1.4.1- |
| | 3 | 2 |
| UE is configured with MCS-C-RNTI | Table 5.1.3.1- | Table 6.1.4.1- |
| | 3 | 2 |
| else | Table 5.1.3.1- | Table 6.1.4.1- |
| | 1 | 1 |

According to one embodiment, if a UE selects a MCS table of one row for a waveform in Table 14, the MCS table of the same row should be selected when another waveform is enabled.

According to another embodiment, if gNB configures one of mcs-Table and mcs-TableTransformPrecoder, upon a dynamic waveform signaling, the same value applies to both parameters. Similarly, if gNB configures one of mcs-TableDCI-0-2-r16 and mcs-TableTransformPrecoderDCI-0-2-r16, the same value applies to the two RRC parameters.

For example, if mcs-Table is set ‘qam64LowSE’, a UE assumes mcs-TableTransformPrecoder is set as ‘qam64LowSE’ too, when it is indicated to switch UL waveform from CP-OFDM to DFT-OFDM. It selects Table 6.1.4.1-2 rather than the default Table 6.1.4.1-1. The former provides more MCS indices with lower code rate.

A somewhat more general embodiment could be expressed as using the same MCS table setting for transmissions using different waveforms. Therefore, in a further variant of embodiments, in a specific embodiment of the general embodiment, the UE additionally receives an indication of an MCS table for the UE to use to determine a modulation order and a target code rate. It determines the modulation order and the target code rate according to the indication for the first and second PUSCH transmissions, and then transmits the first and second transmissions according to the determined modulation order and target code rates.

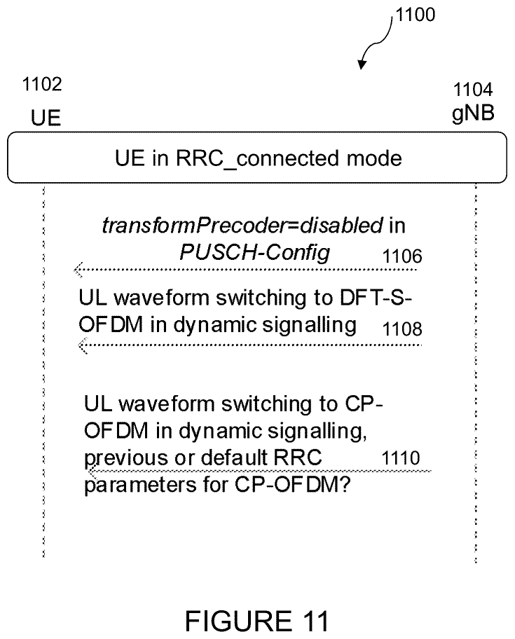

FIG. 11 illustrates a schematic diagram 1100 of switching waveform back and forth, according to certain embodiments. Specifically, FIG. 11 depicts signaling between an example UE 1102 and gNB 1104. A UE is configured one UL waveform-related MCS parameters in RRC, at 1106. At 1108 and 1110, respectively, the UE is indicated to switch to another waveform and then back. In a particular embodiment, the determination of MCS table is according to one or more of the following:
MCS configuration in the most recent RRC configuration.

In other words, the previous RRC configuration is still valid.

UE ignores the previous RRC configuration and uses Table 5.1.3.1-1 or Table 6.1.4.1-1 for CP-OFDM or DFT-S-OFDM.

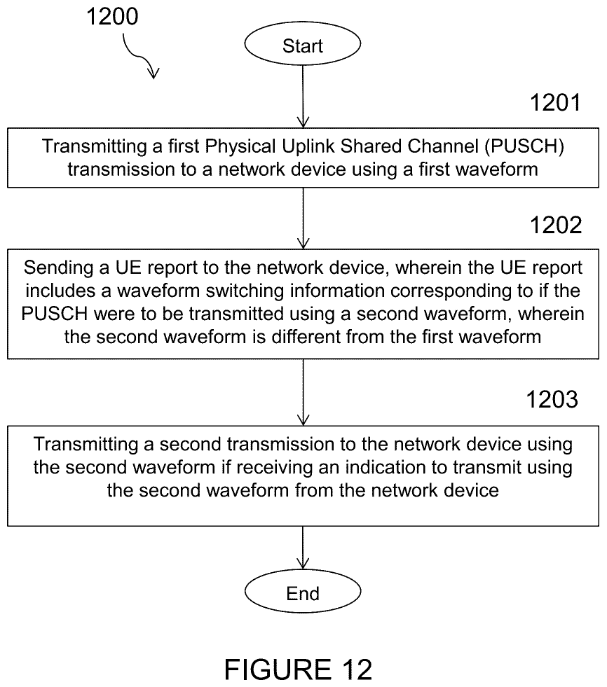

FIG. 12 illustrates an exemplary flow diagram 1200 for a method implemented by a UE for dynamic waveform switching, according to certain embodiments.

With reference to FIG. 12, in step 1201, the UE transmits a first PUSCH transmission to a network device using a first waveform. In step 1202, the UE sends a UE report to the network device. The UE report includes a waveform switching information corresponding to if the PUSCH were to be transmitted using a second waveform, wherein the second waveform is different from the first waveform. In step 1203, the UE transmits a second transmission to the network device using the second waveform if receiving an indication to transmit using the second waveform from the network device.

According to a particular embodiment, the waveform switching information may include a UE performance indication corresponding to if the UE were to transmit using the second waveform.

According to a particular embodiment, the UE may further receive an indication of the second waveform from the network device; and transmit a second transmission to the network device using the second waveform.

According to a particular embodiment, the waveform switching information may include a power headroom corresponding to if the UE were to transmit using the second waveform.

According to a particular embodiment, the first transmission may be transmitted in a first set of physical resource blocks (PRBs) and a first modulation order, and the power headroom is calculated based on the first set of PRBs, the first modulation order and the second waveform.

According to a particular embodiment, the power headroom may be calculated based on a reference transmission corresponding to if the UE were to transmit using the second waveform in a specific set of PRBs and with a specific modulation order.

According to a particular embodiment, the waveform switching information may include a UE's configured maximum output power based on the second waveform.

According to a particular embodiment, the waveform switching information may include the difference between a UE's configured maximum output power based on the first waveform and a UE's configured maximum output power based on the second waveform.

According to a particular embodiment, the waveform switching information may include both a power headroom for the first waveform and a power headroom for the second waveform.

According to a particular embodiment, the UE may further send the UE report including the waveform switching information to the network if a power headroom report timer expires and the difference between a power backoff for the first waveform and a power backoff for the second waveform is larger than a first threshold.

According to a particular embodiment, the UE may further receive a UE report request from the network device to trigger the UE report; and send the UE report including the waveform switching information in response of the UE report request.

According to a particular embodiment, the UE may further send the UE report including the waveform switching information to the network if the difference between a power backoff for the first waveform and a power backoff for the second waveform is larger than a first threshold.

According to a particular embodiment, the UE may further: determine at least one of a first pathloss and a first power management maximum output power reduction associated with the waveform switching information in a prior time instant; determine at least one of a second pathloss and a second power management maximum output power reduction associated with the waveform switching information in a current time instant; and send the UE report including the waveform switching information to the network if at least one of the difference between the first and second pathloss and between the first and second power management maximum output power reduction is greater than a threshold.

According to a particular embodiment, the UE may further: receive parameters to be used for a random access procedure; determine whether to use the first or second waveform during the random access procedure; initiate the random access procedure; transmit a third transmission using the determined first or second waveform during the random access procedure; and transmit a fourth transmission using the second waveform after the random access procedure.

According to a particular embodiment, transmitting using the first waveform is identified as transmitting with transform precoding enabled, and transmitting using the second waveform is identified as transmitting with transform precoding disabled.

According to a particular embodiment, transmitting using the first waveform is identified as transmitting with transform precoding disabled, and transmitting using the second waveform is identified as transmitting with transform precoding enabled.

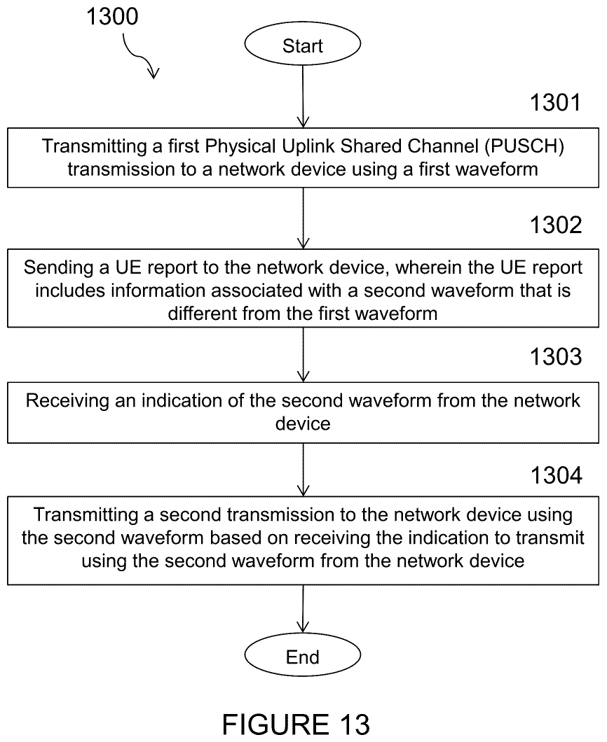

FIG. 13 illustrates an exemplary flow diagram 1300 for another method implemented by a UE for dynamic waveform switching, according to certain embodiments. In the depicted example, the method begins at step 1301 when the UE transmits a first PUSCH transmission to a network device using a first waveform. At 1302, the UE sends a UE report to the network device. The UE report includes information associated with a second waveform that is different from the first waveform. At 1303, the UE receives an indication of the second waveform from the network device. At 1304, the UE transmits a second PUSCH transmission to the network device using the second waveform based on receiving the indication to transmit using the second waveform from the network device.

In a particular embodiment, the UE report comprises a power headroom associated with the second waveform.

In a further particular embodiment, the UE report also comprises a power headroom associated with the first waveform.

In a further particular embodiment, the first PUSCH transmission is transmitted in a first set of PRBs, and with a first modulation order, and the power headroom associated with the second waveform is calculated based on the first set of PRBs, the first modulation order, and the second waveform. Alternatively, in a further particular embodiment, the first PUSCH transmission is transmitted in a first set of PRBs and with a first modulation order, and the power headroom associated with the second waveform is calculated based on a reference transmission associated with the second waveform in a second set of PRBs and with a second modulation order.

In a particular embodiment, the UE report comprises a configured maximum output power based on the second waveform.

In a particular embodiment, the UE report comprises a difference between a configured maximum output power based on the first waveform and a configured maximum output power based on the second waveform.

In a particular embodiment, the UE sends the UE report in response to determining that a difference between a power backoff that the UE requires to transmit using the first waveform and a power backoff that the UE requires to transmit using the second waveform is larger than a first threshold.

In a particular embodiment, when transmitting using the first waveform, the UE transmits with transform precoding enabled, and when transmitting using the second waveform, the UE transmits with transform precoding disabled. Alternatively, in a particular embodiment, when transmitting using the first waveform, the UE transmits with transform precoding disabled, and, when transmitting using the second waveform, the UE transmits with transform precoding enabled.

In a particular embodiment, the indication of the second waveform from the network device is received in a DCI, and the DCI contains a field, for which a bit width is different for the second waveform than a bit width of a field for the first waveform.

In a further particular embodiment, the UE determines that a bit width of the field is greater than 0 for the first waveform when dynamic waveform switching is not configured and is 0 for the second waveform when dynamic waveform switching is not configured. The UE determines the bit width of the field in the DCI for the second waveform to be greater than 0, determines to ignore the field when the second waveform is indicated, and determines whether to use the field when the first waveform is indicated.

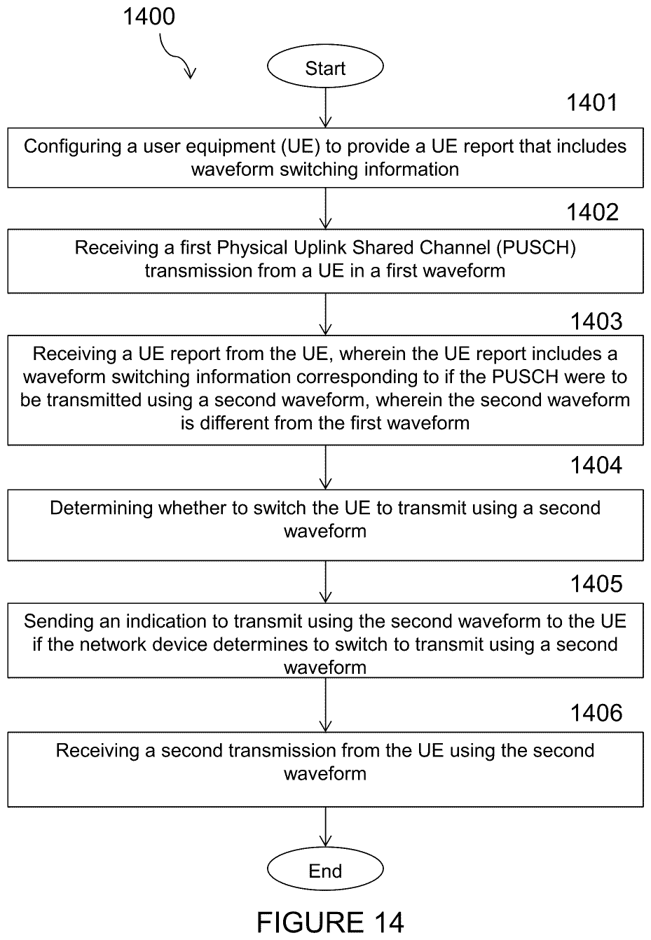

FIG. 14 illustrates an exemplary flow diagram 1400 for a method implemented by a network device for dynamic waveform switching, according to certain embodiments.

With reference to FIG. 14, in step 1401, the network device configures a UE to provide a UE report that includes waveform switching information. In step 1402, the network device may receive a first PUSCH transmission from a UE in a first waveform. In step 1403, the network device receives a UE report from the UE, and the UE report includes a waveform switching information corresponding to if the PUSCH were to be transmitted using a second waveform which is different from the first waveform. In step 1404, the network device determines whether to switch the UE to transmit using a second waveform based on the waveform switching information. In step 1405, the network device sends an indication to transmit using the second waveform to the UE if the network determines to switch the UE to transmit using a second waveform. In step 1406, the network device receives a second transmission from the UE using the second waveform.

According to a particular embodiment, the waveform switching information may include a UE performance indication corresponding to if the UE were to transmitting using the second waveform.

According to a particular embodiment, the waveform switching information may include a power headroom corresponding to if the UE were to transmit using the second waveform.

According to a particular embodiment, the first transmission may be transmitted in a first set of PRBs and a first modulation order, and the power headroom is calculated based on the first set of PRB, the first modulation order and the second waveform.

According to a particular embodiment, the power headroom may be calculated based on a reference transmission in a specific set of PRBs, a specific modulation order, and the second waveform.

According to a particular embodiment, the waveform switching information may include a UE's configured maximum output power based on the second waveform.

According to a particular embodiment, the waveform switching information may include the difference between a UE's configured maximum output power based on the first waveform and a UE's configured maximum output power based on the second waveform.

According to a particular embodiment, the waveform switching information may include both a power headroom for the first waveform and a power headroom for the second waveform.

According to a particular embodiment, the network device may further send a UE report request to the UE to trigger the UE report and receive the UE report including the waveform switching information in response of the UE report request.

According to a particular embodiment, the network device may further: send parameters to be used for a random access procedure; receive a third transmission using the first waveform or the second waveform during the random access procedure; and receive a fourth transmission in using the second waveform after the random access procedure.

According to a particular embodiment, transmitting using the first waveform is identified as transmitting with transform precoding enabled, and transmitting using the second waveform is identified as transmitting with transform precoding disabled.

According to a particular embodiment, transmitting using the first waveform is identified as transmitting with transform precoding disabled, and transmitting using the second waveform is identified as transmitting with transform precoding enabled.

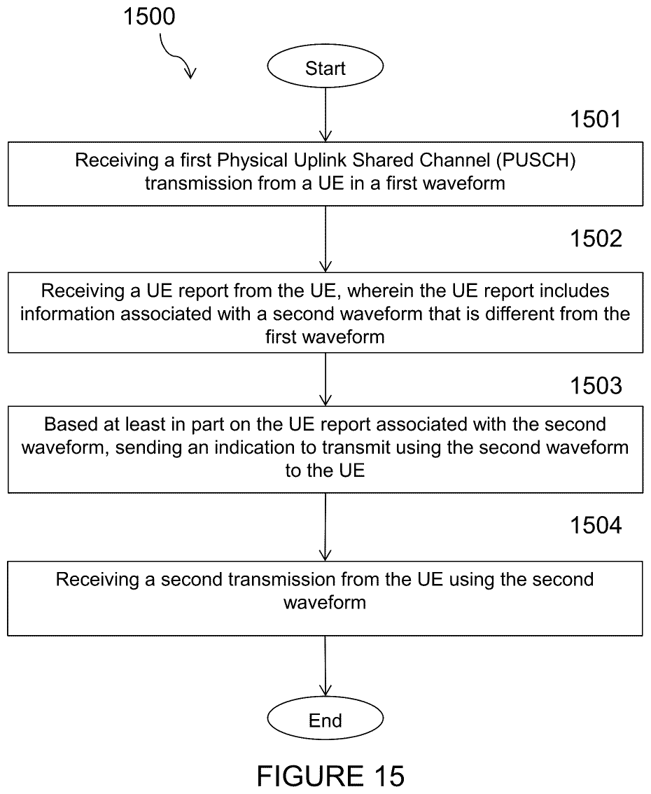

FIG. 15 illustrates an exemplary flow diagram 1500 for another method implemented by a network device for dynamic waveform switching, according to certain embodiments. In the depicted example, the method begins a step 1501 when the network device receives a first PUSCH transmission from a UE in a first waveform. At 1502, the network device receives, from the UE, a UE report. The UE report includes information associated with a second waveform that is different from the first waveform. Based at least in part on the UE report associated with the second waveform, the network device sends an indication to transmit using the second waveform to the UE, at 1503. At 1504, the network device receives a second PUSCH transmission from the UE using the second waveform.

In a particular embodiment, the network device configures the UE to provide the UE report that comprises the waveform switching information.

In a particular embodiment, when sending the indication to the UE based at least in part on the UE report, the network device determines to switch the UE to transmit using the second waveform based on the UE report.

In a particular embodiment, the UE report comprises a power headroom associated with the second waveform. In a further particular embodiment, the UE report additionally comprises a power headroom associated with the first waveform.

In a further particular embodiment, the first PUSCH transmission is transmitted in a first set of PRBs and with a first modulation order, and the power headroom is calculated based on the first set of PRBs, the first modulation order, and the second waveform. Alternatively, in a particular embodiment, the first PUSCH transmission is transmitted in a first set of PRBs and with a first modulation order, and the power headroom is calculated based on a reference transmission in a second set of PRBs, a second modulation order, and the second waveform.

In a particular embodiment, the UE report includes a configured maximum output power based on the second waveform.

In a particular embodiment, the UE report includes a difference between a configured maximum output power based on the first waveform and a configured maximum output power based on the second waveform.

In a particular embodiment, the network device configures the UE to send the UE report when a difference between a power backoff that the UE requires to transmit using the first waveform and a power backoff that the UE requires to transmit using the second waveform is larger than a first threshold.

In a particular embodiment, when the UE transmits using the first waveform, the UE transmits with transform precoding enabled, and when the UE transmits using the second waveform, the UE transmits with transform precoding disabled. Alternatively, in a particular embodiment, when the UE transits using the first waveform, the UE transmits with transform precoding disabled, and when the UE transmits using the second waveform, the UE transmits with transform precoding enabled.

In a particular embodiment, the indication of the second waveform is transmitted to the UE in a DCI, and the DCI contains a field, for which a bit width is different for the second waveform than a bit width of a field for the first waveform.

In a further particular embodiment, the network device configures the UE to: determine that a bit width of the field is greater than 0 for the first waveform when dynamic waveform switching is not configured and is 0 for the second waveform when dynamic waveform switching is not configured; determine the bit width of the field in the DCI for the second waveform to be greater than 0; determine to ignore the field when the second waveform is indicated; and determine whether to use the field when the first waveform is indicated.

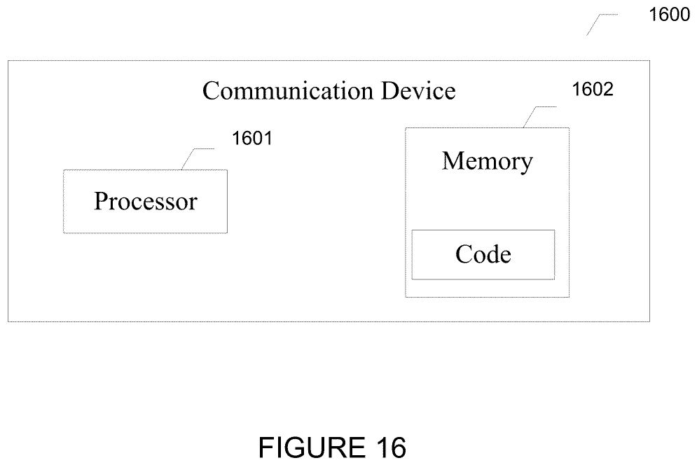

FIG. 16 is a block diagram illustrating a communication device 1600 according to some embodiments of the present disclosure. It should be appreciated that the communication device 1600 may be implemented using components other than those illustrated in FIG. 16.

With reference to FIG. 16, the communication device 1600 may comprise at least a processor 1601, a memory 1602, an interface and a communication medium. The processor 1601, the memory 1602 and the interface are communicatively coupled to each other via the communication medium.

The processor 1601 includes one or more processing units. A processing unit may be a physical device or article of manufacture comprising one or more integrated circuits that read data and instructions from computer readable media, such as the memory 1602, and selectively execute the instructions. In various embodiments, the processor 1601 is implemented in various ways. As an example, the processor 1601 may be implemented as one or more processing cores. As another example, the processor 1601 may comprise one or more separate microprocessors. In yet another example, the processor 1601 may comprise an application-specific integrated circuit (ASIC) that provides specific functionality. In yet another example, the processor 1601 provides specific functionality by using an ASIC and by executing computer-executable instructions.

The memory 1602 includes one or more computer-usable or computer-readable storage medium capable of storing data and/or computer-executable instructions. It should be appreciated that the storage medium is preferably a non-transitory storage medium.

The communication medium facilitates communication among the processor 1601, the memory 1602 and the interface. The communication medium may be implemented in various ways. For example, the communication medium may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium. The interface could be coupled to the processor. Information and data as described above in connection with the methods may be sent via the interface.

In the example of FIG. 16, the instructions stored in the memory 1602 may include those that, when executed by the processor 1601, cause the communication device 1600 to implement the methods described with respect to FIGS. 12-15.

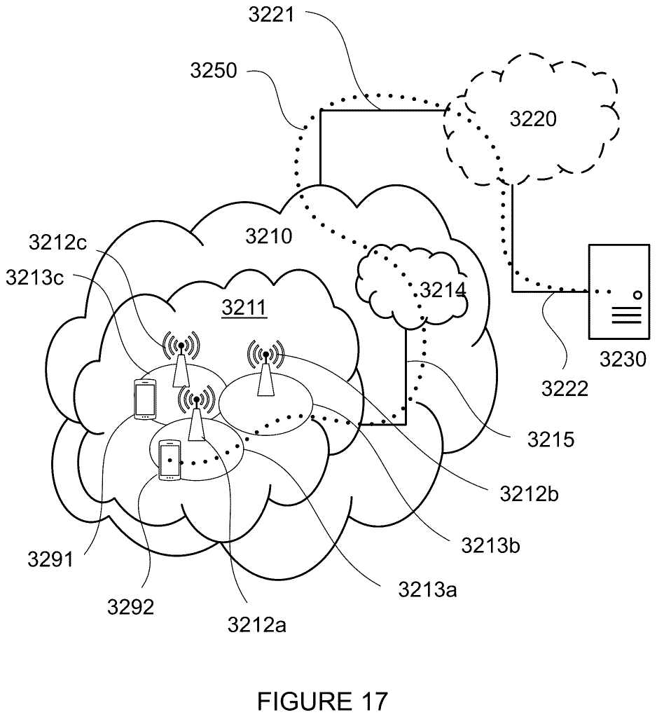

With reference to FIG. 17, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 17 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

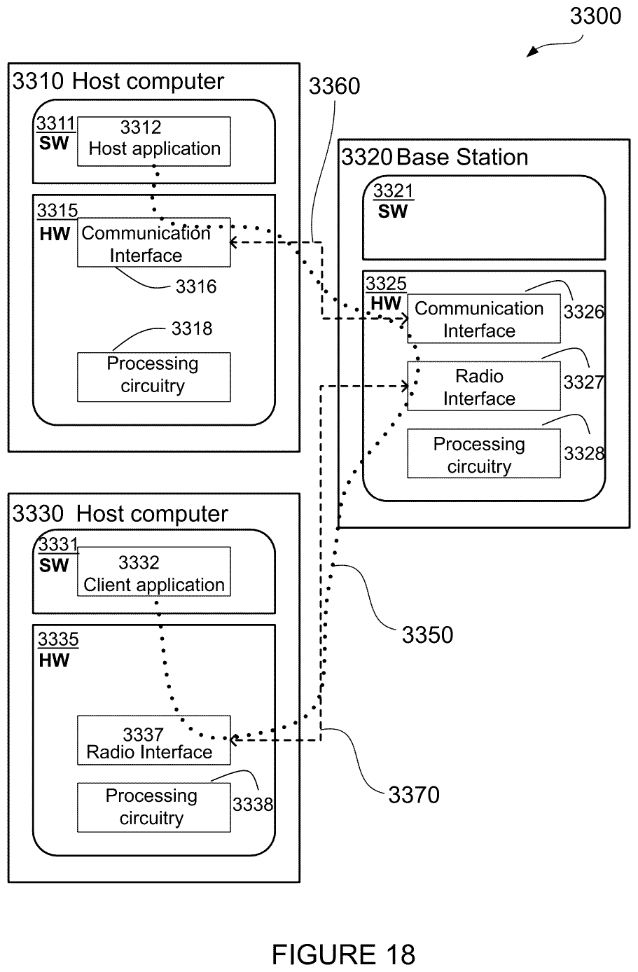

Example implementations, in accordance with an embodiment, of the UE, base station and host computer discussed in the preceding paragraphs will now be described with reference to FIG. 18. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 16) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 18, respectively. This is to say, the inner workings of these entities may be as shown in FIG. 17 and independently, the surrounding network topology may be that of FIG. 17.

In FIG. 18, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

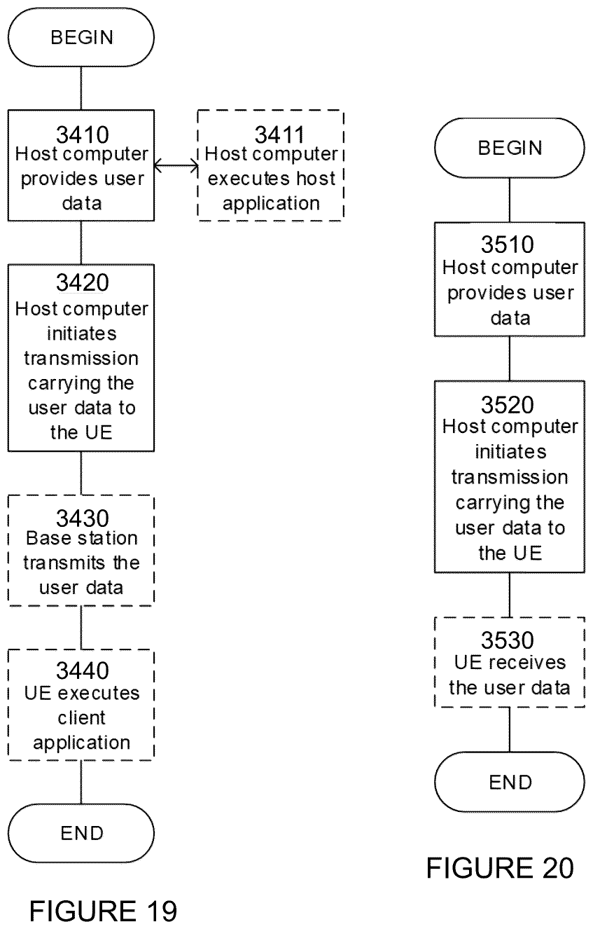

FIG. 19 is a flowchart illustrating a method implemented in a communication system, in accordance with one embodiment. The communication system includes a host computer, a base station and a UE which may be those described with reference to FIG. 17 and FIG. 18. For simplicity of the present disclosure, only drawing references to FIG. 18 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIG. 18 and FIG. 19. For simplicity of the present disclosure, only drawing references to FIG. 20 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

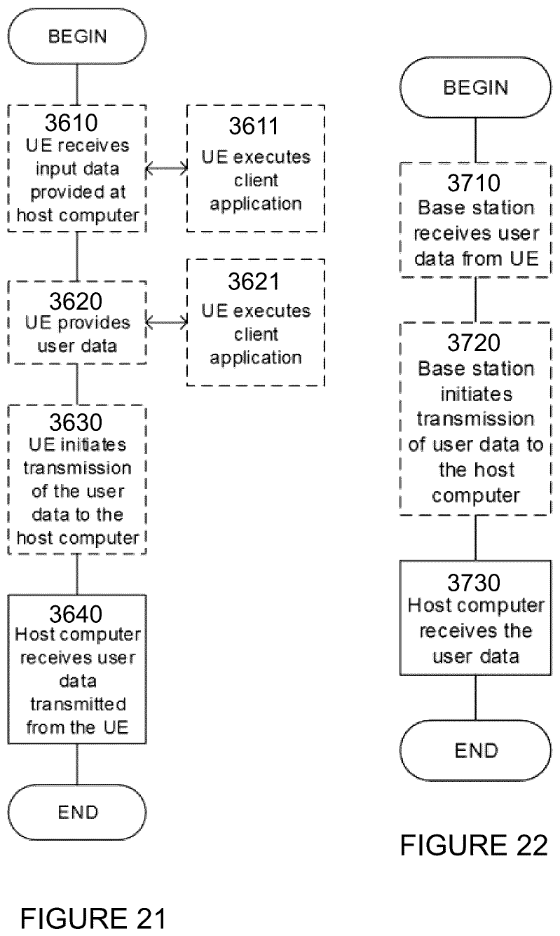

FIG. 21 is a flowchart illustrating a method implemented in a communication system, in accordance with one embodiment. The communication system includes a host computer, a base station and a UE which may be those described with reference to FIG. 17 and FIG. 18. For simplicity of the present disclosure, only drawing references to FIG. 21 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to FIG. 17 and FIG. 18. For simplicity of the present disclosure, only drawing references to FIG. 22 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a user equipment, UE, in a communication network, the method comprising:
transmitting a first Physical Uplink Shared Channel, PUSCH, transmission to a network device using a first waveform;
sending a UE report to the network device, wherein the UE report comprises information associated with a second waveform that is different from the first waveform;
receiving an indication of the second waveform from the network device; and
transmitting a second PUSCH transmission to the network device using the second waveform based on receiving the indication to transmit using the second waveform from the network device.

2. The method of claim 1, wherein the UE report comprises a power headroom associated with the second waveform.

3. The method of claim 2, wherein the UE report also comprises a power headroom associated with the first waveform.

4. The method of claim 2, wherein:
the first PUSCH transmission is transmitted in a first set of physical resource blocks, PRBs, and with a first modulation order, and
the power headroom associated with the second waveform is calculated based on the first set of PRBs, the first modulation order, and the second waveform.

5. The method of claim 2, wherein:
the first PUSCH transmission is transmitted in a first set of physical resource blocks, PRBs, and with a first modulation order, and
the power headroom associated with the second waveform is calculated based on a reference transmission associated with the second waveform in a second set of PRBs and with a second modulation order.

6. The method of claim 1, wherein the UE report comprises a configured maximum output power based on the second waveform.

7. The method of claim 1, wherein the UE report comprises a difference between a configured maximum output power based on the first waveform and a configured maximum output power based on the second waveform.

8. The method of claim 1, comprising:
sending the UE report in response to determining that a difference between a power backoff that the UE requires to transmit using the first waveform and a power backoff that the UE requires to transmit using the second waveform is larger than a first threshold.

9. The method of claim 1, wherein:
transmitting using the first waveform comprises transmitting with transform precoding enabled, and
transmitting using the second waveform comprises transmitting with transform precoding disabled.

10. The method of claim 1, wherein:
transmitting using the first waveform comprises transmitting with transform precoding disabled, and
transmitting using the second waveform comprises transmitting with transform precoding enabled.

11. The method of any one of claim 1, wherein:
the indication of the second waveform from the network device is received in a Downlink Control Information, DCI, and
the DCI contains a field, for which a bit width is different for the second waveform than a bit width of a field for the first waveform.

12. The method of claim 11, comprising:
determining that a bit width of the field is greater than 0 for the first waveform when dynamic waveform switching is not configured and is 0 for the second waveform when dynamic waveform switching is not configured,
determining the bit width of the field in the DCI for the second waveform to be greater than 0,
determining to ignore the field when the second waveform is indicated, and
determining whether to use the field when the first waveform is indicated.

13. A method implemented by a network device in a communication network, the method comprising:
receiving a first Physical Uplink Shared Channel, PUSCH, transmission from a user equipment, UE, in a first waveform;
receiving a UE report from the UE, wherein the UE report comprises information associated with a second waveform that is different from the first waveform;
based at least in part on the UE report associated with the second waveform, sending an indication to transmit using the second waveform to the UE; and
receiving a second PUSCH transmission from the UE using the second waveform.

14. The method of claim 13, comprising configuring the UE to provide the UE report that comprises the waveform switching information.

15. The method of claim 13, wherein sending the indication to the UE based at least in part on the UE report comprises:
determining to switch the UE to transmit using the second waveform based on the UE report.

16. The method of claim 13, wherein the UE report comprises a power headroom associated with the second waveform.

17. The method of claim 16, wherein the UE report additionally comprises a power headroom associated with the first waveform.

18. The method of claim 16, wherein:
the first PUSCH transmission is transmitted in a first set of physical resource blocks, PRBs, and with a first modulation order, and
the power headroom is calculated based on the first set of PRBs, the first modulation order, and the second waveform.

19. The method of claim 16, wherein:
the first PUSCH transmission is transmitted in a first set of physical resource blocks, PRBs, and with a first modulation order, and
the power headroom is calculated based on a reference transmission in a second set of PRBs, a second modulation order, and the second waveform.

20. The method of claim 13, wherein the UE report comprises a configured maximum output power based on the second waveform.

21. The method of claim 13, wherein the UE report comprises a difference between a configured maximum output power based on the first waveform and a configured maximum output power based on the second waveform.

22. The method of claim 14, comprising configuring the UE to send the UE report when a difference between a power backoff that the UE requires to transmit using the first waveform and a power backoff that the UE requires to transmit using the second waveform is larger than a first threshold.

23. The method of claim 13, wherein:
transmitting using the first waveform comprises transmitting with transform precoding enabled, and
transmitting using the second waveform comprises transmitting with transform precoding disabled.

24. The method of claim 13, wherein:
transmitting using the first waveform comprises transmitting with transform precoding disabled, and
transmitting using the second waveform comprises transmitting with transform precoding enabled.

25. (canceled)

26. (canceled)

27. A user equipment, UE, in a communication network, the UE adapted to:
transmit a first Physical Uplink Shared Channel, PUSCH, transmission to a network device using a first waveform;
send a UE report to the network device, wherein the UE report comprises information associated with a second waveform that is different from the first waveform;
receive an indication of the second waveform from the network device; and
transmit a second PUSCH transmission to the network device using the second waveform based on receiving the indication to transmit using the second waveform from the network device.

28. (canceled)

29. A network device in a communication network, the network node adapted to:
receive a first Physical Uplink Shared Channel, PUSCH, transmission from a user equipment, UE, in a first waveform;
receive a UE report from the UE, wherein the UE report comprises information associated with a second waveform that is different from the first waveform;
based at least in part on the UE report associated with the second waveform, send an indication to transmit using the second waveform to the UE; and
receive a second PUSCH transmission from the UE using the second waveform.

30. (canceled)
